(19) United States
(12) Patent Application Publication
(10) Pub. No.: US 2025/0137369 A1
(43) Pub. Date: May 1, 2025

(54) AZIMUTHAL AND RADIAL DEPTH FOCUSING FOR WELLBORE TUBULAR DEFECT EVALUATION

(71) Applicant: Halliburton Energy Services, Inc., Houston, TX (US)

(72) Inventors: Ahmed Fouda, Houston, TX (US); Joao Vicente Goncalves Rocha, Rio de Janeiro (BR); Leonardo Kessler Slongo, Rio de Janeiro (BR)

(21) Appl. No.: 18/798,573

(22) Filed: Aug. 8, 2024

Related U.S. Application Data
(60) Provisional application No. 63/549,788, filed on Feb. 5, 2024.
(60) Provisional application No. 63/593,759, filed on Oct. 27, 2023.

(51) Int. Cl. E21B 47/092; E21B 47/005

(52) U.S. Cl. CPC E21B 47/092; E21B 47/005; E21B 2200/22

(57) ABSTRACT

A downhole tool to identify a defect in a wellbore tubular comprises a transmitter array of N transmitter coils, wherein a moment of each of the N transmitter coils are to point in a different azimuthal direction, wherein each of the N transmitter coils is to emit an excitation signal independent of the other N transmitter coils. The downhole tool comprises a receiver array of M receiver coils, wherein a moment of each of the M receiver coils are to point in a different azimuthal direction, wherein each of the M receiver coils is to measure a response signal derived from the excitation signal from each of the N transmitter coils. A processor processes, based on a set of scaling weights, the response signal measured by each of the M receiver coils derived from the excitation signals emitted from each of the transmitter coils to create a processed response.

### BACKGROUND

Early detection of metal loss of well components, like production tubing or casing, is of great importance to hydrocarbon wells management. Currently, remote field eddy current tools may detect anomalies on multiple nested tubulars. However, this type of tool has low vertical resolution and no azimuthal discrimination. That means the estimated metal loss is an average value of annular section of the wellbore tubular within the tool vertical resolution range. Therefore, current tools may fail to detect tubular flaws, such as cracks, pitting, holes. Additionally, average metal loss will underestimate the severity of damage and that may result in expensive remedial actions and shut down of production wells.

### BRIEF DESCRIPTION OF THE DRAWINGS

Embodiments of the disclosure may be better understood by referencing the accompanying drawings.

FIG. 1 is a schematic diagram of an example wireline system according to some embodiments.

FIG. 2 is a perspective side view of an example of transmitter and receiver coils oriented in the R direction, according to some embodiments.

FIG. 3 is a perspective side view of an example of transmitter and receiver coils oriented in the Z direction and R direction, respectively, according to some embodiments.

FIG. 4 is a perspective side view of an example of transmitter and receiver coils oriented in the Z direction, according to some embodiments.

FIG. 5 is a perspective side view of an example of transmitter and receiver coils oriented in the Phi direction, according to some embodiments.

FIG. 6 is a perspective side view of an example of transmitter and receiver coils oriented in the R direction and Phi direction, respectively, according to some embodiments.

FIG. 7 is a perspective side view of an example of transmitter and receiver coils oriented in the Phi direction and Z direction, respectively, according to some embodiments.

FIG. 8 is a block diagram of a flowchart of example operations for software-based focused azimuthal wellbore tubular defect evaluation, according to some embodiments.

FIG. 9 is a block diagram of a flowchart of example operations for hardware-based focusing for azimuthal wellbore tubular defect evaluation, according to some embodiments.

FIG. 10 is a block diagram of a flowchart of example operations for software-based focusing for azimuthal wellbore tubular defect evaluation, according to some embodiments.

FIG. 11 is an example plot of a data matrix derived from response signals measured by multiple receiver coils in response to exciting each one of the transmitter coils from a transmitter array, according to some embodiments.

FIG. 12 is a plot of an example focused response after focusing via signal processing, according to some embodiments.

FIG. 13 is a plot of a focused response after hardware focusing via signal processing, according to some embodiments.

FIG. 14 is a cross-sectional top side view down into a wellbore, having a tool that includes a transmitter array with multiple transmitter coils positioned in multiple wellbore tubulars, according to some embodiments.

FIG. 15 is a plot of the initial responses of receiver coils from the excitations from the different transmitter coils of FIG. 14, according to some embodiments.

FIGS. 16-19 are cross-sectional top side views down into a wellbore, having a tool that includes a transmitter array with multiple transmitter coils positioned in multiple wellbore tubulars having a defect of varying widths, according to some embodiments.

FIG. 20 is a plot of an example focused response after software focusing via signal processing of the defects of varying widths of FIGS. 16-19, according to some embodiments.

FIG. 21 is a cross-sectional top side view down into a wellbore, having a tool that includes a transmitter array with multiple transmitter coils positioned in a production tubing that is within a casing having a defect that is a hole, according to some embodiments.

FIG. 22 is a perspective view of a portion of casing and production tubing of FIG. 21, according to some embodiments.

FIG. 23 is a plot of an example focused response after software focusing via signal processing of the defect (a hole in the casing) of FIGS. 21-22, according to some embodiments.

FIG. 24 is a perspective view of example nested wellbore tubulars that includes an inner tubing positioned with a casing (each having a defect), according to some embodiments.

FIG. 25 is a block diagram of a flowchart of example operations for performing radial depth focusing wellbore tubular defect evaluation, according to some embodiments.

FIG. 26 is a block diagram of a flowchart of example operations for software-based radial depth focusing wellbore tubular defect evaluation, according to some embodiments.

FIG. 27 is a block diagram of a flowchart of example operations for hardware-based radial depth focusing wellbore tubular defect evaluation, according to some embodiments.

FIG. 28 is a plot of the data extracted from the diagonals of a raw data matrix, respectively, according to some embodiments.

FIG. 29 is a plot of the data extracted from the transmitters of a raw data matrix, respectively, according to some embodiments.

FIG. 30 is a plot of the data extracted from the receivers of a raw data matrix, respectively, according to some embodiments.

FIG. 31 is a plot of an intermediate response from a set of scaling weights obtained based on focusing on the casing and defocusing on the inner tubing applied to the raw data of FIG. 30 (derived from the rows (the receivers) of the raw data matrix), according to some embodiments.

FIG. 32 is a plot of an intermediate response from a set of scaling weights obtained based on focusing on the casing and defocusing on the inner tubing applied to the raw data of FIG. 29 (derived from the columns (the transmitters) of the raw data matrix), according to some embodiments.

FIG. 33 is a plot of an intermediate response from a set of scaling weights obtained based on focusing on the inner tubing and defocusing on the casing applied to the raw data of FIG. 30 (derived from the rows (the receivers) of the raw data matrix), according to some embodiments.

FIG. 34 is a plot of an intermediate response from a set of scaling weights obtained based on focusing on the inner tubing and defocusing on the casing applied to the raw data of FIG. 29 (derived from the columns (the transmitters) of the raw data matrix), according to some embodiments.

FIG. 35 is a plot of a final casing response that focuses on the casing and defocuses on the inner tubing using a first radial profile starting from a same data matrix, according to some embodiments.

FIG. 36 is a plot of a final inner tubing response that focuses on the inner tubing and defocuses on the casing using a second radial profile starting from the same data matrix, according to some embodiments.

FIG. 37 is a block diagram of an example computer, according to some embodiments.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

Example implementations may include evaluation of defects in wellbore tubulars (such as pipe, casing, etc.) positioned downhole in a wellbore. Example implementations may include a directional electromagnetic tool configured to make an azimuthal measurement of corrosion with radial depth focusing. For example, example implementations may include an electromagnetic tool with azimuthal sensitivity for and beyond the immediate pipe in which the tool is logged (such as tubing) and through-tubing azimuthal defect evaluation with radial depth focusing.

Some implementations may include an electromagnetic tool with azimuthal sensitivity for and beyond the immediate wellbore tubular in which the tool is logged (i.e. tubing) and through-tubing azimuthal defect evaluation. Example implementations may include an electromagnetic tool capable of making azimuthal measurements of corrosion through tubing achieved by new sensor array configuration and an array signal processing focusing methodology to focus the raw measurements and increase the azimuthal resolution.

The electromagnetic tool may include an array of N transmitter coils disposed azimuthally within the pipe and an array of M receiver coils disposed azimuthally within the pipe. In some implementations, N and M are greater than one. The electromagnetic tool may also include a controller to excite each one of the transmitters independently and then record a data matrix of N×M responses. From the data matrix, a processor may generate at least one focused response with a radial depth of investigation that is substantially different from the data matrix.

Example implementations may also include a method for focusing the response of the N×M data matrix response of the electromagnetic azimuthal tool. Such a method may include a training step for computing a set of scaling weights, and a processing step in which the scaling weights are applied to the acquired data matrix to compute a focused response with enhanced azimuthal resolution.

Example implementations may include a tool that is able to provide improved azimuthal information of a defect with high resolution for well tubings (such as the immediate pipe). Additionally, the tool may be able to provide improved azimuthal information of a defect with high resolution for well casings beyond the immediate wellbore tubular. The tool may have a focused algorithm using array signal processing techniques to improve the azimuthal resolution response. Additionally, the tool may have a focused algorithm that may produce more than one response with different radial depths of investigation.

In example implementations, the tool may include an array of non-axial coils with moments pointing in different azimuthal directions. In some implementations, data acquired by the tool may be visualized as three-dimensional (3-D) images, wherein one dimension is axial depth, a second dimension is azimuth, and third dimension is radial depth.

Conventional approaches are limited to providing an average value of metal loss on an annular section of the pipe within the tool vertical resolution range. In contrast, example implementations may provide both azimuthal and axial information of corrosion with high resolution. Such implementations may greatly improve pipe integrity inspection. In particular, the severity of damage may be more accurately estimated by knowing the azimuthal extent of the anomaly. Example implementations may enhance azimuthal resolution and suppress sidelobe artifacts present in the acquired data.

Monitoring the condition of the casing strings is crucial in hydrocarbon recovery operations. Electromagnetic (EM) techniques are common in inspection of these components. To acquire stronger response from the outer wellbore tubular of a nested tubulars, typically, a larger transmitter coil is employed together with larger receiver coils that are placed at large distances away from the transmitter with low frequency excitation. However, such measurements degrade the vertical (along the depth) resolution in the thickness estimation results, and since omnidirectional coils are used, measurements made by such tools lack any directional sensitivity. In contrast, example implementations may include an electromagnetic azimuthal downhole tool and method for evaluating defects in well casings composed of at least one pipe.

Example implementations may include a downhole tool for monitoring the integrity of at least two nested well tubulars. There are conventional approaches to identify defects in a well tubular. However, such conventional approaches are based on omni-directional eddy current tools.

In contrast, example implementations may include a downhole tool having an array of N (N>1) transmitter coils disposed azimuthally within the at least two nested tubulars and an array of M receiver coils disposed azimuthally within the at least two nested tubulars. In some implementations, N and M may be greater than one. Example implementations may include a controller that may control the exciting of each of the transmitter coils independently. Some implementations may include operations to focus the response of a downhole azimuthal defect evaluation tool. Also, some implementations may include operations for electronic beamsteering of a downhole azimuthal defect evaluation tool. In some implementations, a processor may generate (from the data matrix) at least one focused response with a radial depth of investigation that is substantially different from the data matrix.

Example implementations may include a radial depth focusing. In some implementations, a same procedure used in software and hardware focusing to create a set of weights to combine the data matrix into a single focused response for the casing string may also be used to create an optimal set of weights for the inner tubing or string. In some implementations, one step further is to modify the optimization strategy such that while focusing on the casing at the same time there is a defocusing on tubing and vice-versa. Accordingly, example implementations may include operations to create a workflow for radial depth focusing as well as azimuthal focusing. Such focusing/defocusing operations may create undesired artifacts on the final individual responses. These artifacts may be suppressed by doing a combination using different extractions of the raw data matrix, together with focused response in relation to rows and columns of the data matrix (as further described below).

Example implementations are described in reference to occurring during a production operation using a wireline for detection defects in a wellbore tubular. However, example implementations may be applicable to any other type of wellbore operation at any other stage of hydrocarbon recovery. For example, some implementations may be used during drilling, completion, workover and intervention, etc. Additionally, example implementations may use other types of tools for detection (such as a slickline tool).

Furthermore, while described in reference to identifying a defect of an outer wellbore tubular of a nested group of wellbore tubulars, example implementations may be used to identify a defect of a single wellbore tubular, a non-outer wellbore tubular of a nested group of wellbore tubulars, etc.

### Example System

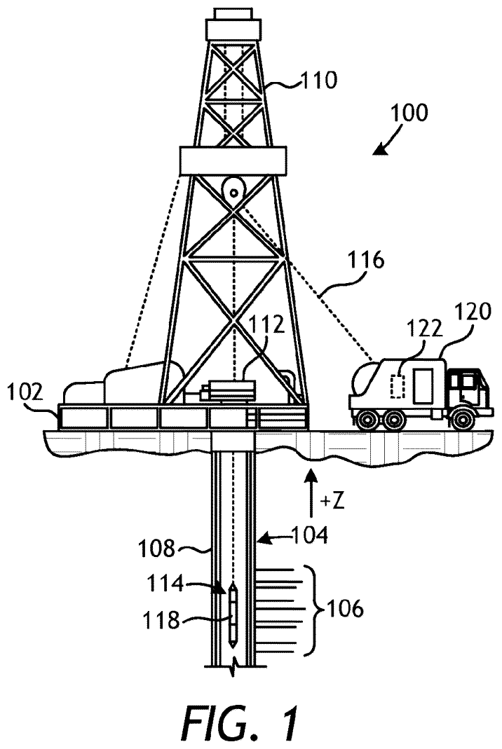

FIG. 1 is a schematic diagram of an example wireline system according to some embodiments. As illustrated, a wireline system 100 may include a surface platform 102 positioned at the earth's surface and a wellbore 104 that extends from the surface platform 102 into one or more subterranean formations 106. In other embodiments, such as in offshore operations, a volume of water may separate the surface platform 102 and the wellbore 104. The wellbore 104 may be lined with one or more wellbore tubulars 108, also referred to casing, tubings (such as production tubing), pipe (such as drill pipe). In some embodiments, portions of the wellbore 104 may have only one wellbore tubular 108 positioned therein, but other portions of the wellbore 104 may be lined with two or more concentrically disposed wellbore tubulars 108. The wellbore tubulars 108 may be made of plain carbon steel, stainless steel, or another material capable of withstanding a variety of forces, such as collapse, burst, and tensile failure.

The wireline system 100 may include a derrick 110 supported by the surface platform 102 and a wellhead installation 112 positioned at the top of the wellbore 104. A downhole tool 114 may be suspended into the wellbore 104 on a cable 116. In some embodiments, the downhole tool 114 may alternatively be suspended within a production tubing (not shown) positioned within the wellbore tubulars 108 that line the wellbore 104 (i.e., casing). In such embodiments, the production tubing may extend by itself within the wellbore tubulars 108 or alternatively be positioned adjacent one or more eccentrically located production tubing that are also positioned within the wellbore tubulars 108. Accordingly, as used herein, “wellbore tubulars 108” may refer to casing that line the wellbore 104, at least one production tubing extended into the wellbore 104, etc.

The downhole tool 114 may comprise an electromagnetic, non-destructive inspection tool. Its operation may be based on either the flux-leakage principle or the eddy-current principle, or a combination thereof, and may be insensitive to non-magnetic deposits and is operable irrespective of the nature of the fluid mixture flowing into/out of the wellbore 104. The downhole tool 114 can be used for the detection of localized damage or defects in the wellbore tubulars 108. In operation, the wellbore tubulars 108 may be subjected to a strong primary magnetic field produced by the downhole tool 114 and, due to their ferromagnetic nature, eddy currents will be generated inside the wellbore tubulars. These eddy currents produce secondary magnetic fields that are measured along with the primary magnetic field with the downhole tool 114. In the presence of discontinuities or defects in the metal of the wellbore tubulars 108, such as pits and holes caused by corrosion, the changes in the secondary magnetic field can be detected with the downhole tool 114.

To accomplish this, the downhole tool 114 may include one or more transmitter coils and/or one or more receiver coils (transceiver coils) 118, which may be communicably coupled to the cable 116. The cable 116 may include conductors for conveying power to the downhole tool 114 and also for facilitating communication between the surface platform 102 and the downhole tool 114. A logging facility 120, shown in FIG. 1 as a truck, may collect measurements from the transceiver coils 118, and may include computing facilities 122 for controlling, processing, storing, and/or visualizing the measurements gathered by the transceiver coils 118. The computing facilities 122 may be communicably coupled to the downhole tool 114 by way of the cable 116.

The transceiver coils 118 may include one or more electromagnetic coil antennas that may be used as transmitters, receivers, or a combination of both (i.e., transceivers) for obtaining in situ measurements of the wellbore tubulars 108 and thereby determining the structural integrity or condition of each wellbore tubular 108. Multiple measurements may be made by the transceiver coils 118 as the downhole tool 114 is lowered into the wellbore 104 (i.e., “down log”) and/or raised back to the surface of the well (i.e., “up log”). Each measurement gives an indication of the condition of the wellbore tubulars 108 at the specific depth where the downhole tool 114 is located.

The principle of measurement is based on two separate mechanisms: magnetic fields that follow the magnetically shortest path (such as in magnetic circuits) and eddy currents that are induced on the wellbore tubulars 108, which create signals as a function of the electromagnetic skin depth of the wellbore tubulars 108. Received signals are also affected by casing collars and natural changes in the magnetic properties of different pieces of a wellbore pipe. After received signals are recorded, they are interpreted by an algorithm, and features of the wellbore tubulars 108 can be calculated from the measurements. These calculations and determinations can be undertaken, for example, using the computing facilities 122 at the logging facility 120. Advantageously, electromagnetic inspection tools, such as the downhole tool 114, provide a capability to make measurements of the wellbore tubulars 108 beyond the first or innermost wellbore tubular.

In some embodiments, the transceiver coils 118 may be designed to operate in a centralized position within the innermost wellbore tubular 108, such as through the use of one or more centralizers (not shown) attached to the body of the downhole tool 114. In other embodiments, however, the transceiver coils 118 may be designed to be adjacent or in intimate contact with the inner wall of the innermost wellbore tubular 108. In such embodiments, the transceiver coils 118 may be mounted on one or more deployable sensor pads (not shown) positioned on actuatable arms (not shown) that move the transceiver coils 118 radially outward toward the inner wall of the innermost wellbore tubular 108.

In some implementations, the wireline system 100 may include a processor 188 that may be local or remote from the wellbore 104. In some implementations, the processor 188 may be at the surface or downhole in the wellbore 104. For example, the processor 188 may be part of the downhole tool 114. As further described below, the processor 188 may perform at least some of the operations for evaluation of defects in wellbore tubulars (such as pipe, casing, etc.) positioned downhole in the wellbore 104. For example, the processor 188 may perform processing to enable hardware-focusing, software-focusing, etc. (as further described below).

### Example Downhole Tools

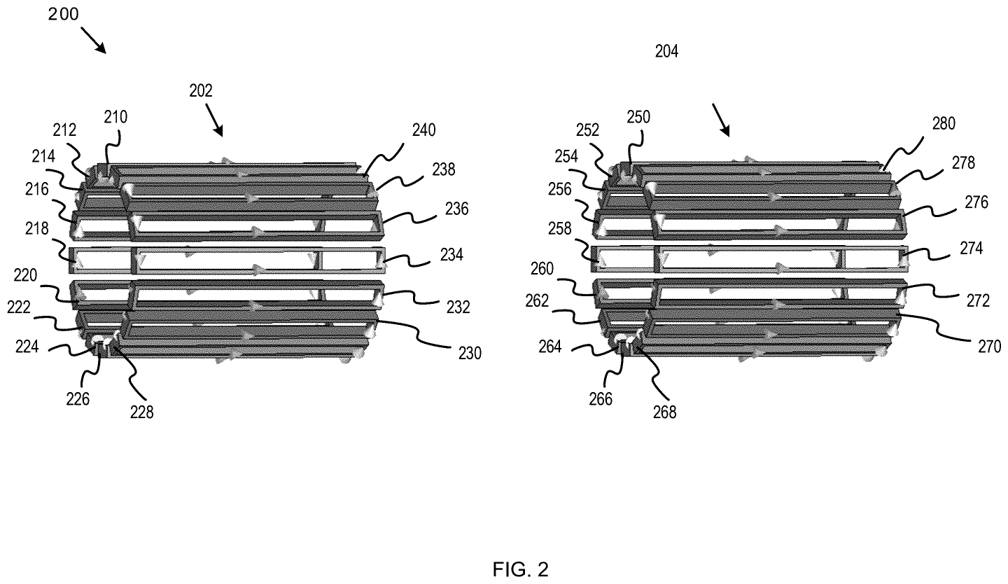

FIG. 2 is a schematic side view of an example downhole tool having both a receiver array of receiver coils and a transmitter array of transmitter coils both oriented in a radial (R) direction, according to some embodiments. FIG. 2 depicts a downhole tool 200 that may be an example of the downhole tool 114 of FIG. 1. As shown, the downhole tool 200 may be an electromagnetic azimuthal downhole tool for evaluating defects in a wellbore tubular. The downhole tool 200 includes an array of N transmitter coils 204 (transmitter array 204) that may be disposed azimuthally within the wellbore tubular downhole in a wellbore. In some implementations, N is greater than one. In this example, the transmitter array 204 includes 16 transmitter coils (transmitter coils 250-280). In some implementations, each of the transmitter coils 250-280 may operate to emit an excitation signal outward and independent of each other. In this example, each of the transmitter coils 250-280 is oriented in the R direction.

The downhole tool 200 also includes an array of M receiver coils 202 (receiver array 202) that may be disposed azimuthally within the wellbore tubular downhole in a wellbore. In some implementations, M is greater than one. In this example, the receiver array 202 includes 16 receiver coils (receiver coils 210-240). In this example, both the transmitter array 204 and the receiver array 202 may be configured in a crown configuration (as shown). Each of the receiver coils 210-240 may separately measure a response signal that is generated in response to each of the excitation signals that is emitted by each of the transmitter coils 250-280. In this example, each of the transmitter coils 250-280 and each of the receiver coils 210-240 are oriented in the R direction.

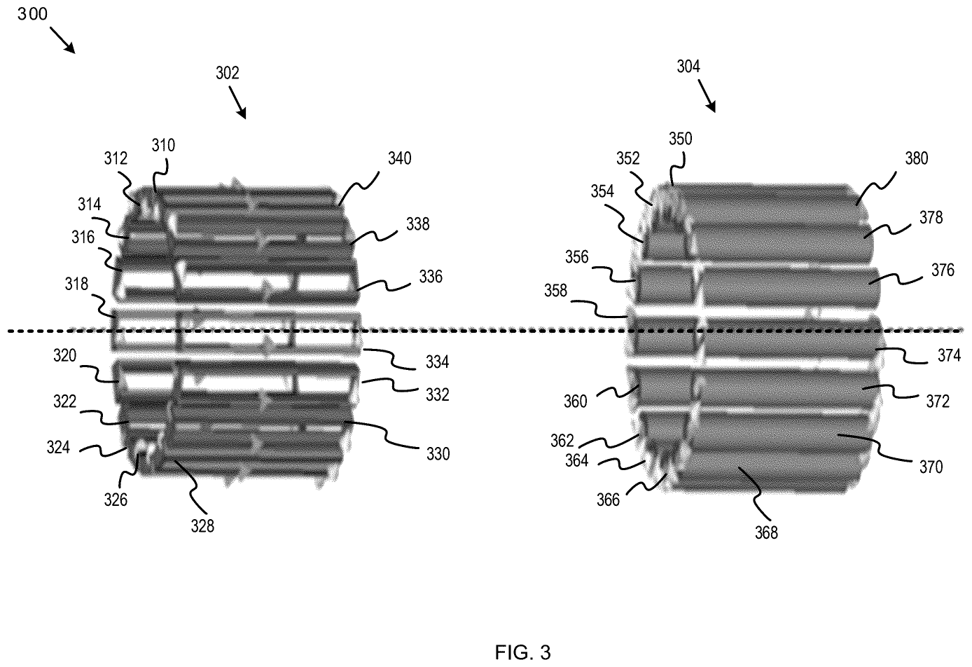

FIG. 3 is a perspective side view of an example of transmitter and receiver coils oriented in the Z direction and R direction, respectively, according to some embodiments. FIG. 3 depicts a downhole tool 300 that may be an example of the downhole tool 114 of FIG. 1. As shown, the downhole tool 300 may be an electromagnetic azimuthal downhole tool for evaluating defects in a wellbore tubular. The downhole tool 300 includes an array of N transmitter coils 304 (transmitter array 304) that may be disposed azimuthally within the wellbore tubular downhole in a wellbore. In some implementations, N is greater than one. In this example, the transmitter array 304 includes 16 transmitter coils (transmitter coils 350-380). In some implementations, each of the transmitter coils 350-380 may operate to emit an excitation signal outward and independent of each other.

The downhole tool 300 also includes an array of M receiver coils 302 (receiver array 302) that may be disposed azimuthally within the wellbore tubular downhole in a wellbore. In some implementations, M is greater than one. In this example, the receiver array 302 includes 16 receiver coils (receiver coils 310-340). In this example, both the transmitter array 304 and the receiver array 302 may be configured in a crown configuration (as shown). Each of the receiver coils 310-340 may separately measure a response signal that is generated in response to each of the excitation signals that is emitted by each of the transmitter coils 350-380. In this example, each of the transmitter coils 350-380 is oriented in the Z direction and each of the receiver coils 310-340 is oriented in the R direction. Alternatively, each of the transmitter coils 350-380 may be oriented in the R direction and each of the receiver coils 310-340 may be oriented in the Z direction.

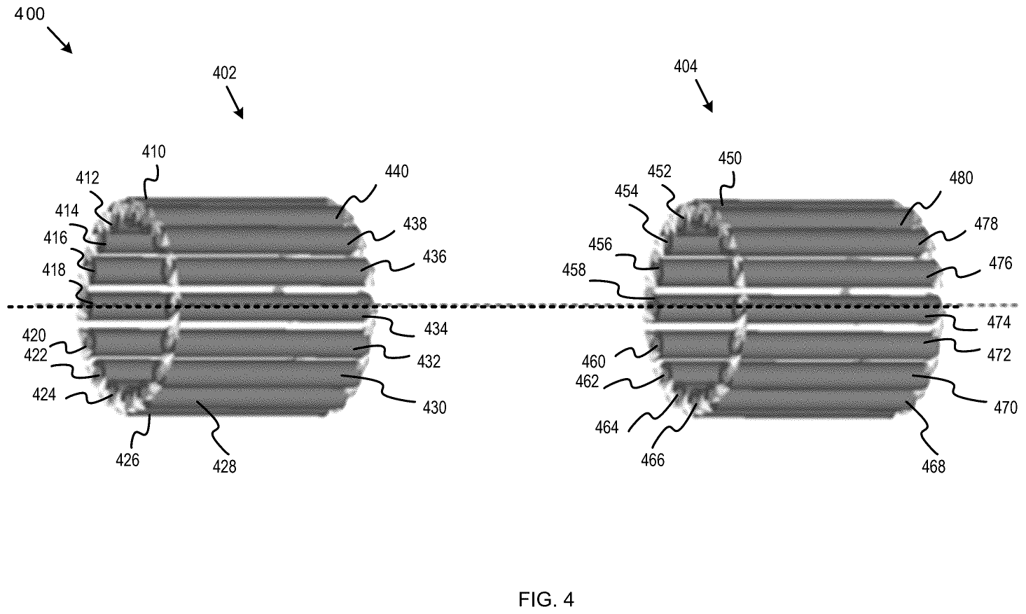

FIG. 4 is a perspective side view of an example of transmitter and receiver coils oriented in the Z direction, according to some embodiments. FIG. 4 depicts a downhole tool 400 that may be an example of the downhole tool 114 of FIG. 1. As shown, the downhole tool 400 may be an electromagnetic azimuthal downhole tool for evaluating defects in a wellbore tubular. The downhole tool 400 includes an array of N transmitter coils 404 (transmitter array 404) that may be disposed azimuthally within the wellbore tubular downhole in a wellbore. In some implementations, N is greater than one. In this example, the transmitter array 404 includes 16 transmitter coils (transmitter coils 450-480). In some implementations, each of the transmitter coils 450-480 may operate to emit an excitation signal outward and independent of each other.

The downhole tool 400 also includes an array of M receiver coils 402 (receiver array 402) that may be disposed azimuthally within the wellbore tubular downhole in a wellbore. In some implementations, M is greater than one. In this example, the receiver array 402 includes 16 receiver coils (receiver coils 410-440). In this example, both the transmitter array 404 and the receiver array 402 may be configured in a crown configuration (as shown). Each of the receiver coils 410-440 may separately measure a response signal that is generated in response to each of the excitation signals that is emitted by each of the transmitter coils 450-480. In this example, each of the transmitter coils 450-480 is oriented in the Z direction and each of the receiver coils 310-340 is oriented in the Z direction.

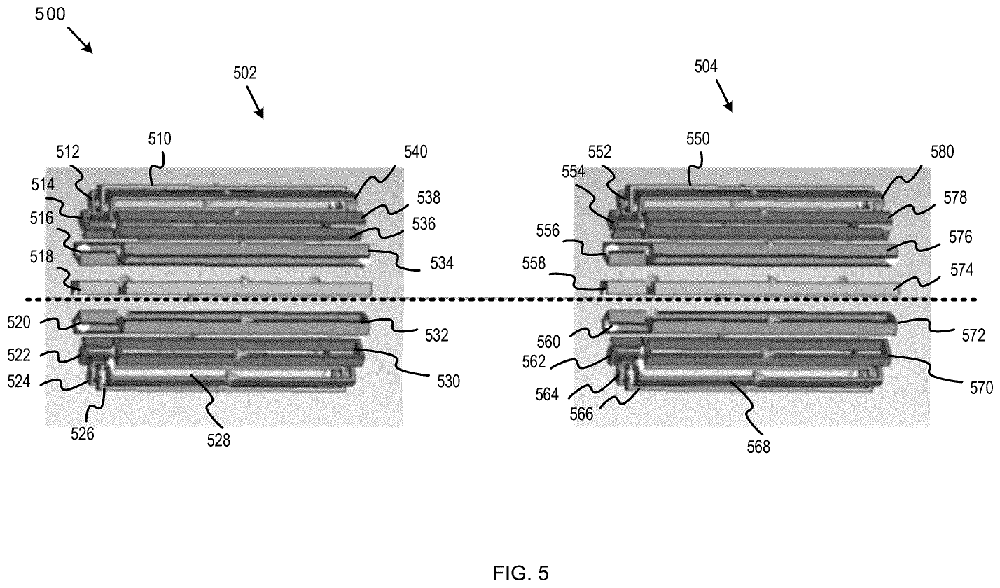

FIG. 5 is a perspective side view of an example of transmitter and receiver coils oriented in the Phi direction, according to some embodiments. FIG. 5 depicts a downhole tool 500 that may be an example of the downhole tool 114 of FIG. 1. As shown, the downhole tool 500 may be an electromagnetic azimuthal downhole tool for evaluating defects in a wellbore tubular. The downhole tool 500 includes an array of N transmitter coils 504 (transmitter array 504) that may be disposed azimuthally within the wellbore tubular downhole in a wellbore. In some implementations, N is greater than one. In this example, the transmitter array 504 includes 16 transmitter coils (transmitter coils 550-580). In some implementations, each of the transmitter coils 550-580 may operate to emit an excitation signal outward and independent of each other.

The downhole tool 500 also includes an array of M receiver coils 502 (receiver array 502) that may be disposed azimuthally within the wellbore tubular downhole in a wellbore. In some implementations, M is greater than one. In this example, the receiver array 502 includes 16 receiver coils (receiver coils 510-540). In this example, both the transmitter array 504 and the receiver array 502 may be configured in a crown configuration (as shown). Each of the receiver coils 510-540 may separately measure a response signal that is generated in response to each of the excitation signals that is emitted by each of the transmitter coils 550-580. In this example, each of the transmitter coils 550-580 is oriented in the Phi direction and each of the receiver coils 510-540 is oriented in the Phi direction.

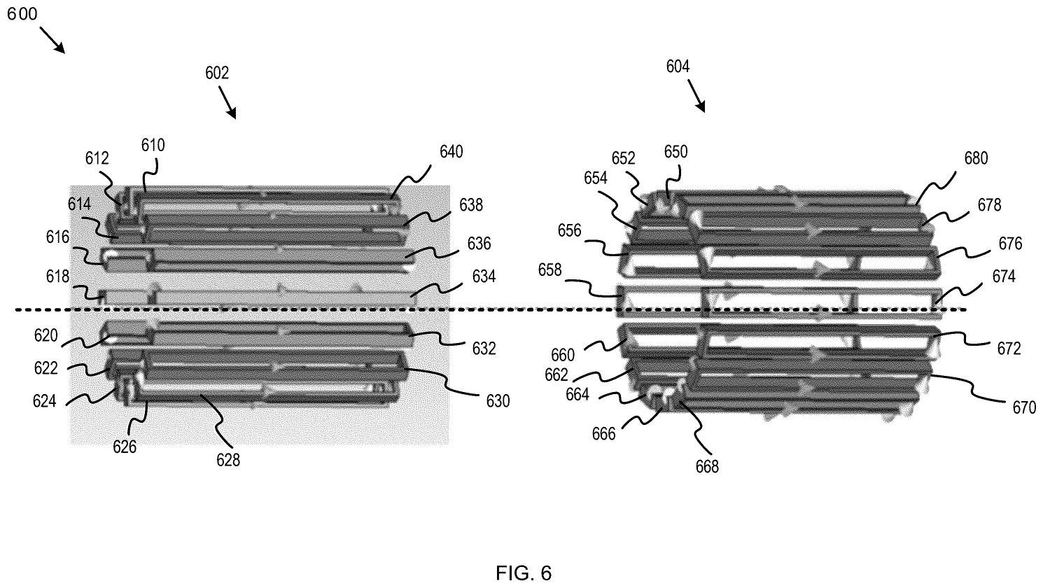

FIG. 6 is a perspective side view of an example of transmitter and receiver coils oriented in the R direction and Phi direction, respectively, according to some embodiments. FIG. 6 depicts a downhole tool 600 that may be an example of the downhole tool 114 of FIG. 1. As shown, the downhole tool 600 may be an electromagnetic azimuthal downhole tool for evaluating defects in a wellbore tubular. The downhole tool 600 includes an array of N transmitter coils 604 (transmitter array 604) that may be disposed azimuthally within the wellbore tubular downhole in a wellbore. In some implementations, N is greater than one. In this example, the transmitter array 604 includes 16 transmitter coils (transmitter coils 650-680). In some implementations, each of the transmitter coils 650-680 may operate to emit an excitation signal outward and independent of each other.

The downhole tool 600 also includes an array of M receiver coils 602 (receiver array 602) that may be disposed azimuthally within the wellbore tubular downhole in a wellbore. In some implementations, M is greater than one. In this example, the receiver array 602 includes 16 receiver coils (receiver coils 610-640). In this example, both the transmitter array 604 and the receiver array 602 may be configured in a crown configuration (as shown). Each of the receiver coils 610-640 may separately measure a response signal that is generated in response to each of the excitation signals that is emitted by each of the transmitter coils 650-680. In this example, each of the transmitter coils 650-680 is oriented in the R direction and each of the receiver coils 610-640 is oriented in the Phi direction. Alternatively, each of the transmitter coils 650-680 may be oriented in the Phi direction and each of the receiver coils 610-640 may be oriented in the R direction.

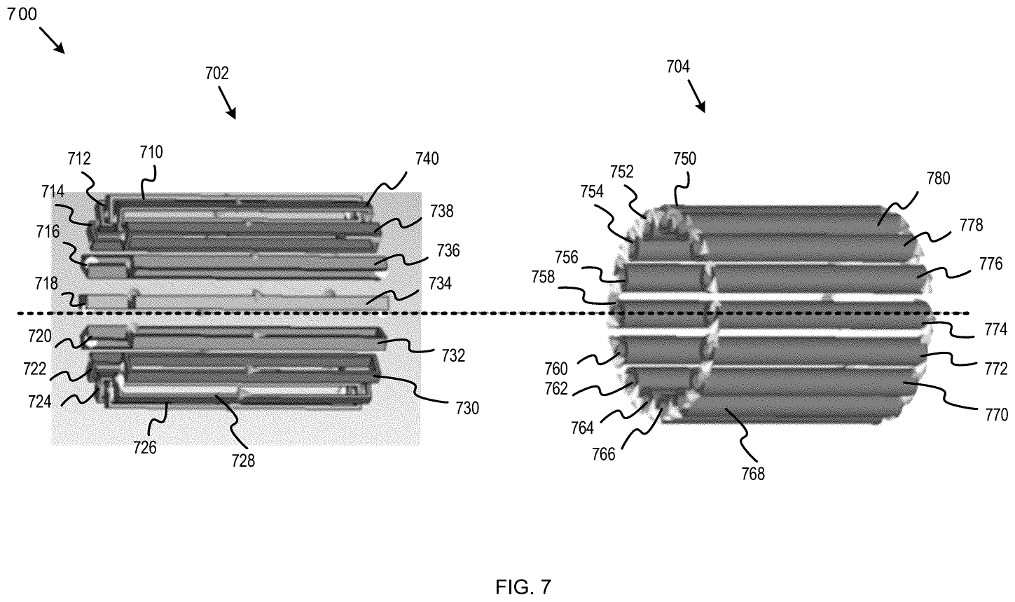

FIG. 7 is a perspective side view of an example of transmitter and receiver coils oriented in the Phi direction and Z direction, respectively, according to some embodiments. FIG. 7 depicts a downhole tool 700 that may be an example of the downhole tool 114 of FIG. 1. As shown, the downhole tool 700 may be an electromagnetic azimuthal downhole tool for evaluating defects in a wellbore tubular. The downhole tool 700 includes an array of N transmitter coils 704 (transmitter array 704) that may be disposed azimuthally within the wellbore tubular downhole in a wellbore. In some implementations, N is greater than one. In this example, the transmitter array 704 includes 16 transmitter coils (transmitter coils 750-780). In some implementations, each of the transmitter coils 750-780 may operate to emit an excitation signal outward and independent of each other.

The downhole tool 700 also includes an array of M receiver coils 702 (receiver array 702) that may be disposed azimuthally within the wellbore tubular downhole in a wellbore. In some implementations, M is greater than one. In this example, the receiver array 702 includes 16 receiver coils (receiver coils 710-740). In this example, both the transmitter array 704 and the receiver array 702 may be configured in a crown configuration (as shown). Each of the receiver coils 710-740 may separately measure a response signal that is generated in response to each of the excitation signals that is emitted by each of the transmitter coils 750-780. In this example, each of the transmitter coils 750-780 is oriented in the Phi direction and each of the receiver coils 710-740 is oriented in the Z direction. Alternatively, each of the transmitter coils 750-780 may be oriented in the Z direction and each of the receiver coils 710-740 may be oriented in the Phi direction.

A controller may control each one of the transmitters independently such that each transmitter may emit a signal independent of the other transmitters. The receiver coils may detect each of the transmitted signals-resulting in a data matrix of N×M responses being recorded (wherein N is the number of transmitter coils and M is the number of receiver coils).

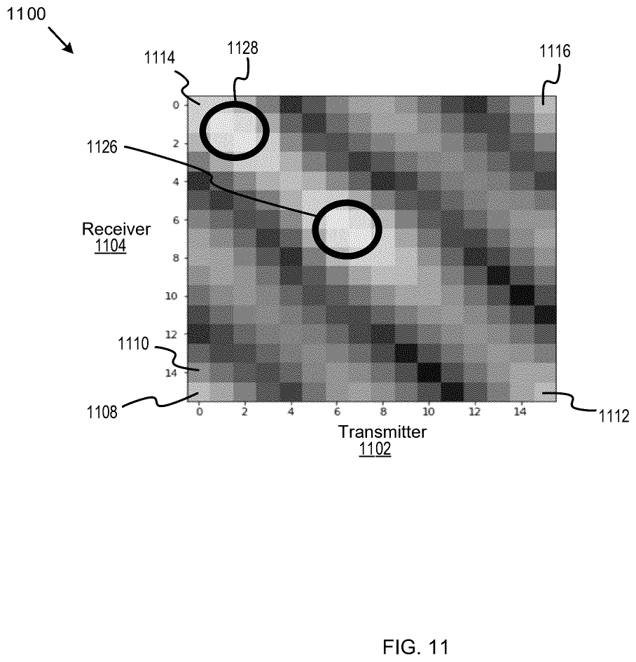

In some implementations, the transmitter coils may be excited with continuous-wave current at one or more frequencies, and the receiver coils may measure the amplitude and phase or real and imaginary parts of the voltage at the one or more frequencies. In some implementations, each of the N transmitter coils may be excited sequentially (time-division multiplexing) and all M receiver responses may be acquired for each transmitter coil excitation. A data matrix of N×M responses may be constructed and presented as a two-dimensional (2D) image (as shown in FIG. 11, which is further described below).

### Example Operations

a. Focused Azimuthal Wellbore Tubular Defect Evaluation

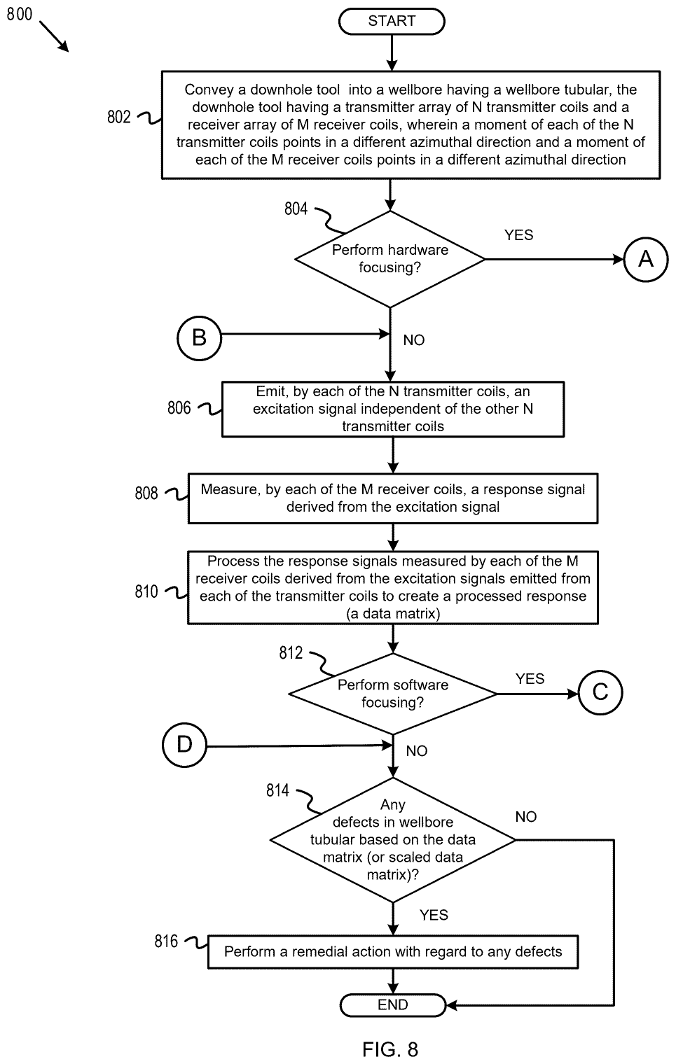

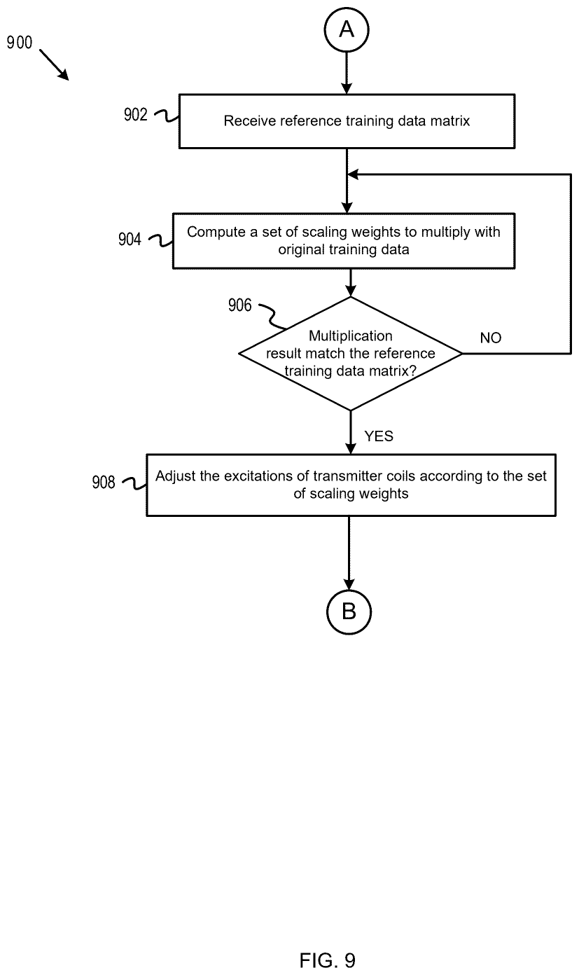

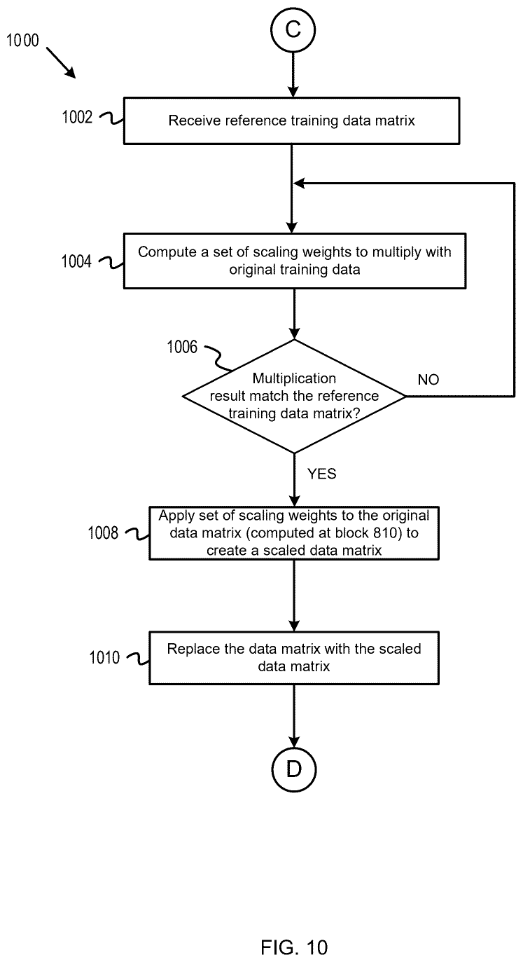

Example operations for focused azimuthal wellbore tubular defect evaluation are now described with reference to flowcharts of FIGS. 8-10. FIG. 8 is a block diagram of a flowchart of example operations for performing focused azimuthal wellbore tubular defect evaluation, according to some embodiments. FIG. 9 is a block diagram of a flowchart of example operations for hardware-based focusing for azimuthal wellbore tubular defect evaluation, according to some embodiments. FIG. 10 is a block diagram of a flowchart of example operations for software-based focusing for azimuthal wellbore tubular defect evaluation, according to some embodiments.

Operations of flowcharts 800, 900, and 1000 of FIGS. 8-10, respectively, may be performed by software, firmware, hardware, or a combination thereof. Operations of the flowcharts 800-1000 continue among each other through transition points A, B, C, and D. Operations of the flowcharts 800-1000 are described in reference to FIGS. 1-2. However, other systems and components can be used to perform the operations now described. Operations of the flowchart 800 start at block 802.

At block 802, a downhole tool is conveyed into a wellbore having a wellbore tubular. For example, with reference to FIG. 2, the downhole tool 200 may include the transmitter array 204 of N transmitter coils and the receiver array 202 of M receiver coils. In some implementations, a moment of each of the N transmitter coils may point in a different azimuthal direction and a moment of each of the M receiver coils may point in a different azimuthal direction. With reference to FIG. 1, the downhole tool 114 may be conveyed down the wellbore 104 into one or more wellbore tubulars. For example, the downhole tool 114 may be lowered into a production tubing that includes a casing around the wellbore 104. The downhole tool 114 may be used to detect defects of a wellbore tubular at different depths of the wellbore 104.

At block 804, a determination is made of whether hardware focusing for azimuthal wellbore tubular defect evaluation is to be performed. For example, with reference to FIG. 1, the processor 188 may make this determination. In some implementations this determination may be based on a control setting, the type of wellbore that was drilled, the type of wellbore tubulars on which defect evaluation is performed, the type of subsurface formation into which the wellbore is formed, etc. If it is determined that hardware focusing is to be performed, operations of the flowchart 800 continue at transition point A, which continues at transition point A of the flowchart 900 (which is further described below). Otherwise, operations of the flowchart 800 continue at block 806.

At block 806, each of the N transmitter coils emit an excitation signal independent of the other N transmitter coils. For example, with reference to FIG. 2, each of the N transmitter coils 250-280 of the transmitter array 204 may emit an excitation signal independent of the other transmitter coils of the transmitter array 204.

At block 808, each of the M receiver coils measures a response signal derived from each of the excitation signals. For example, with reference to FIG. 2, each of the M receiver coils 210-240 of the receiver array 202 may measure a response signal derived from each excitation signal emitted by each of the transmitter coils 250-280 of the receiver array 202.

At block 810, the response signals measured by each of the M receiver coils derived from the excitation signals emitted from each of the transmitter coils are processed to create a processed response (a data matrix). For example, with reference to FIG. 1, the processor 188 may process the response signals to create a processed response (a data matrix).

To illustrate, FIG. 11 is an example plot of a data matrix derived from response signals measured by multiple receiver coils in response to exciting each one of the transmitter coils from a transmitter array, according to some embodiments. FIG. 11 illustrates a plot 1100 that is a two-dimensional (2D) image having an x-axis 1102 that includes a column for each of the 16 transmitter coils (0-15) and a y-axis 1104 that includes a row for each of the 16 receiver coils (0-15).

The downhole tool may measure the complex-valued voltage response of each receiver coil when powering the transmitter coils with a known and controlled signal. Different components of the complex-valued measurements may be displayed in the 2D image. For example, the plot 1100 may display the absolute, phase, real or imaginary measurements. In the example of the plot 1100 of FIG. 11, each column represents the absolute of the complex-valued data acquired by all receiver coils when just the transmitter coil in each position is firing.

Each block in the plot may be a magnitude of the voltage of the response signal measured by a given receiver coil derived from an emitted signal emitted by a given transmitter coil. In this example of the plot 1100, the lighter the block, the more likely that there is a defect. Thus, a location 1126 identifies a likely location of a defect. Conversely, the darker the block, the less likely that there is a defect. The emitted signal may be a sinusoidal current. The magnitude of the voltage of the response signal may be a complex number. A location 1128 may appear to be a likely location of a defect but is actually a false positive that may be caused by mirroring of the data associated with the actual data. This false positive may be filtered out (as further described below).

Accordingly, the plot 1100 of the data matrix may represent the measurements of each receiver coil with an associated emitted signal. Thus, a combination of a given measurement and associated emitted signal may be independent of the other combinations. In other words, for this example, for each emission by a given transmitter there are 16 measurements from 16 different receiver coils (0-15) that are represented by a color for a given block in the data matrix of the plot 1100.

Thus, in this example, the plot 1100 represents 256 combinations of emitted signals and received signals. For example, a block 1108 may represent a magnitude of the voltage of the response signal measured by the receiver coil 15 derived from an emitted signal emitted by the transmitter coil 0. A block 1110 may represent a magnitude of the voltage of the response signal measured by the receiver coil 14 derived from an emitted signal emitted by the transmitter coil 0. A block 1112 may represent a magnitude of the voltage of the response signal measured by the receiver coil 15 derived from an emitted signal emitted by the transmitter coil 15. A block 1114 may represent a magnitude of the voltage of the response signal measured by the receiver coil 0 derived from an emitted signal emitted by the transmitter coil 0. A block 1116 may represent a magnitude of the voltage of the response signal measured by the receiver coil 0 derived from an emitted signal emitted by the transmitter coil 15, etc.

Returning to FIG. 8, operations of the flowchart 800 continue at block 812.

At block 812, a determination is made of whether software focusing for azimuthal wellbore tubular defect evaluation is to be performed. For example, with reference to FIG. 1, the processor 188 may make this determination. In some implementations this determination may be based on a control setting, the type of wellbore that was drilled, the type of wellbore tubulars on which defect evaluation is performed, the type of subsurface formation into which the wellbore is formed, etc. If it is determined that software focusing is to be performed, operations of the flowchart 800 continue at transition point C, which continues at transition point C of the flowchart 1000 (which is further described below). Otherwise, operations of the flowchart 800 continue at block 814.

At block 814, a determination is made of whether there are any defects detected in the wellbore tubular based on the data matrix (or the scaled data matrix if software focusing is performed). For example, with reference to FIG. 1, the processor 188 may make this determination. If there are no defects detected in the wellbore tubular, operations of the flowchart 800 are complete. Otherwise, operations of the flowchart 800 continue at block 816.

At block 816, a remedial action with regard to any defects is performed. For example, the remedial action may include at least one of repairing or replacing a section of the wellbore tubular with a defect. Additionally, the severity, number, location, etc. of defects may determine the type of remedial action. For example, if there is a single minor defect, this section of the wellbore tubular may be repaired. In another example, if there are numerous and/or severe defects, this section of the wellbore tubular may be replaced. Operations of the flowchart 800 are complete.

Operations for hardware-based focusing for azimuthal wellbore tubular defect evaluation of the flowchart 900 are now described. Operations of the flowchart 900 start at transition point A (from the transition point A of the flowchart 800). From the transition point A, operations continue at block 902.

At block 902, a reference training data matrix is received. For example, with reference to FIG. 1, the processor 188 may receive the reference training data matrix. In some implementations, the reference training data matrix may be created based on simulations or actual data of similar environments (such as similar types of wellbore tubulars, the nesting of the wellbore tubulars, etc.). To illustrate, FIG. 11

At block 904, a set of scaling weights is computed to multiply with original training data. For example, with reference to FIG. 1, the processor 188 may perform this computing of the set of scaling weights. The original training data may be the data used to derive the reference training data matrix.

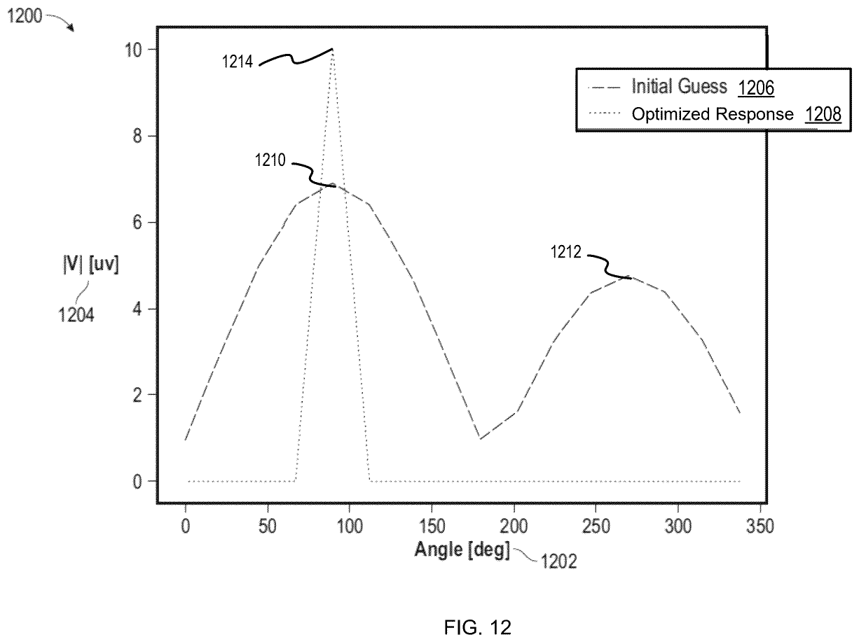

To illustrate, FIG. 12 is a plot of a focused response after focusing via signal processing, according to some embodiments. A plot 1200 of FIG. 12 may be an example of software focusing (which is further described below). However, this example of FIG. 12 will help illustrate the computation and application of a set of scaling weights that may be applicable to both hardware and software focusing.

A plot 1200 includes an x-axis 1202 that is the azimuthal direction having ranges of approximately 0-360 degrees and a y-axis 1204 that is a magnitude of the voltage of the response signal. The plot 1200 includes an initial guess 1206 that includes the response measured by the receiver coils (prior to software focusing via signal processing). The initial guess 1206 includes two peaks that may be likely defects in the wellbore tubular-a first peak 1210 (at approximately 90 degrees) and a second peak 1212 (at approximately 275 degrees). The first peak 1210 is identified as a likely defect, and the second peak 1212 is a false positive. Accordingly, after signal processing, an optimized response 1208 (corresponding with an ideal response) is generated with—further highlighting the likely defect at a peak 1214 (at approximately 90 degrees) and removal of the false positive (at approximately 275 degrees). If the correct set of scaling weights are used for multiplying with the training data, the optimized response 1208 may be the same or substantially the same as the ideal response. Substantially the same may be a difference that is within a threshold. For example, if the difference between the optimized response 1208 and the ideal response are less than 1%, 5%, 10%, etc., the optimized response 1208 is substantially the same as the ideal response.

Thus, as shown in FIG. 12, the initial unfocused guess 1206 may be updated to create the optimized response 1208 by multiplying the original training data with a correct set of scaling weights. In particular in this example, the initial unfocused guess is processed to matching the narrow slot defect pulse at approximately 90 degrees. Accordingly, different sets of scaling weights may result in different differences between the optimized response 1208 and the ideal response. Thus, the set of scaling weights that result in the minimal difference between the optimized response 1208 and the ideal response may be selected. Accordingly, the plot 1200 of the data matrix may be optimized to increase the resolution using signal processing (software focusing) to output a more accurate angular resolution of any defects.

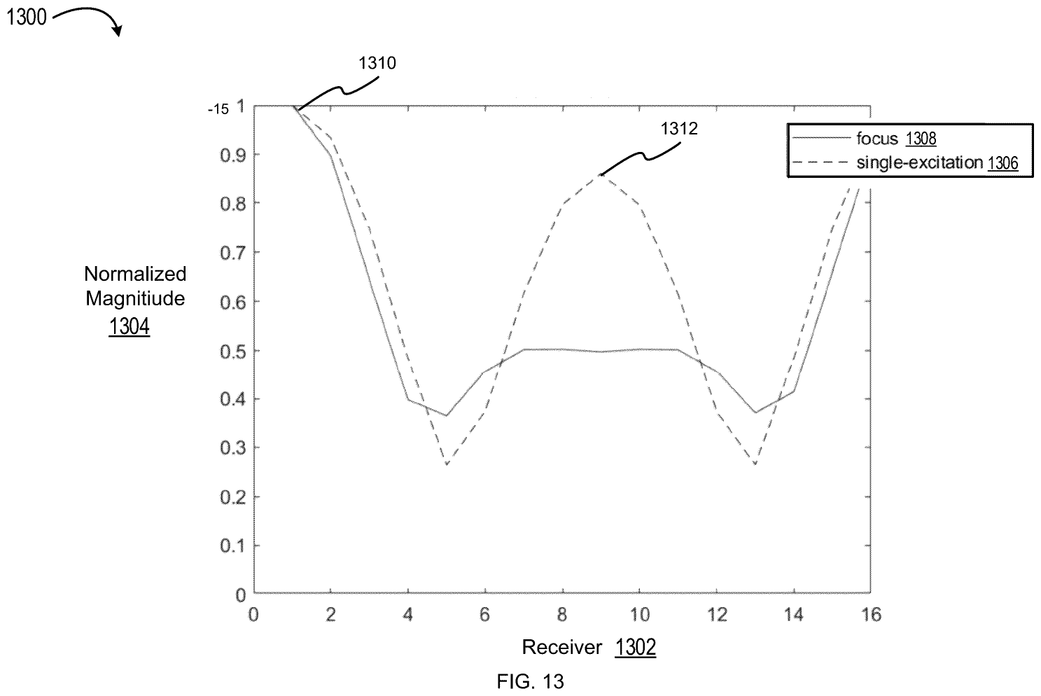

To further illustrate, FIG. 13 is a plot of a focused response after hardware focusing via signal processing, according to some embodiments. FIG. 13 is a plot 1300 that includes an x-axis 1302 that is the number of the receiver coil (1-16) and a y-axis 1304 that is a normalized magnitude of the received signal. A dashed line 1306 represents an EM field pattern of a single excitation before hardware focusing (that includes applying the set of scaling weights). A solid line 1308 represents the EM field pattern after hardware focusing (that includes applying the set of scaling weights).

The EM field after focusing (shown by the solid line 1308) shows a preferred direction in the receiver #1 where the defect is (at or near point 1310). The dashed line 1306 includes a redundancy peak (before focusing) on the other side of the crown of the receiver array (at or near point 1312—the receiver #9). As shown, this redundancy peak at point 1312 is substantially removed by the focusing.

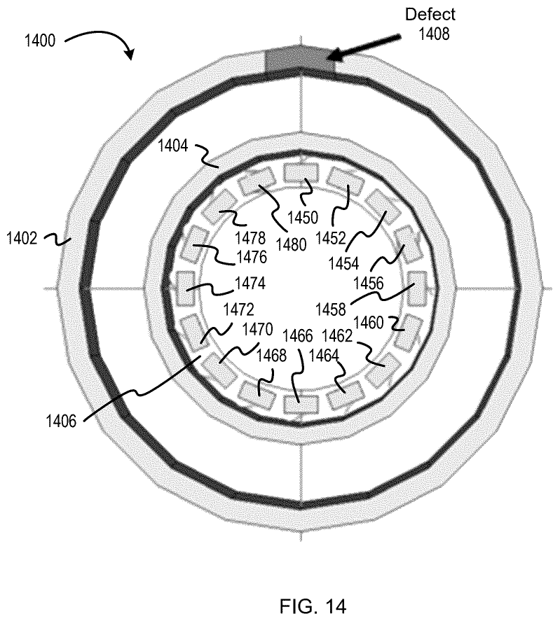

To further illustrate, FIG. 14 is a cross-sectional top side view down into a wellbore, having a tool that includes a transmitter array with multiple transmitter coils positioned in multiple wellbore tubulars, according to some embodiments. FIG. 14 depicts a cross-sectional top view down into a wellbore 1400 having two wellbore tubulars (1402 and 1404). For example, the wellbore tubular 1402 may be casing, and the wellbore tubular 1404 may be production tubing. In this example, the wellbore tubular 1402 includes a defect 1408. FIG. 14 also includes a transmitter array 1406 (that is part of a downhole tool) that is positioned within both of the wellbore tubulars 1402 and 1404. In this example, the transmitter array 1406 includes 16 transmitter coils 1450-1480 (positioned at different azimuthal positions within the wellbore 1400.

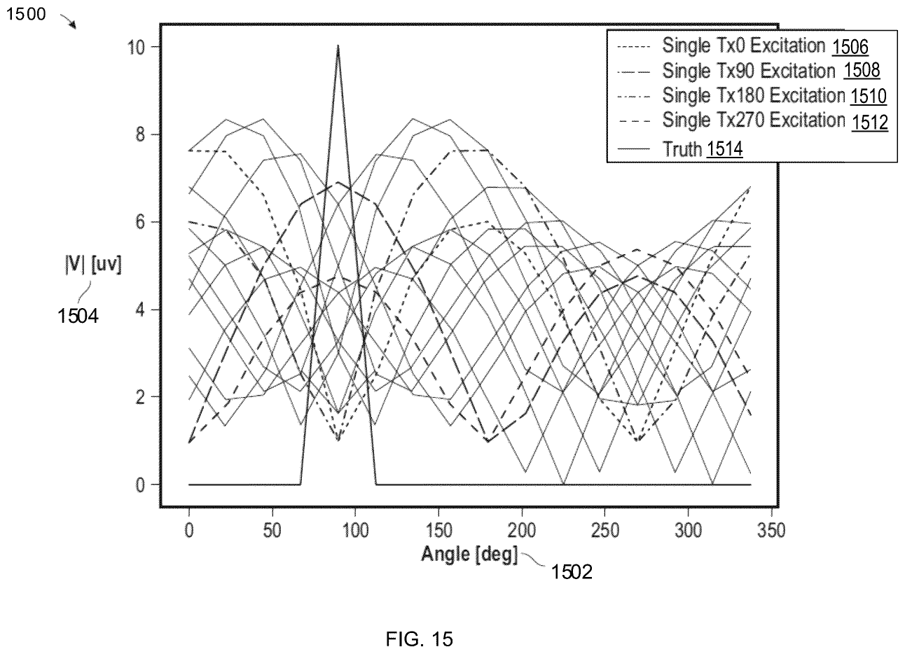

FIG. 15 is a plot of the initial responses of receiver coils from the excitations from the different transmitter coils of FIG. 14, according to some embodiments. FIG. 15 depicts a plot 1500 that includes an x-axis 1502 is the azimuthal direction having ranges of approximately 0-360° and a y-axis 1504 that is a magnitude of the voltage of the response signal.

The plot 1500 includes the initial responses (including a single transmitter excitation for the transmitter at 0° 1506, a single transmitter excitation for the transmitter at 90° 1508, a single transmitter excitation for the transmitter at 180° 1510, and a single transmitter excitation for the transmitter at 270° 1512). After determining the initial responses, optimization operations may calculate and find the optimal weights for each single transmitter excitation to approximate the final linear weighted answer from the tool to determine the known ground truth—shown as a truth response 1514. The optimal scaling weights may be calculated using Equation (1)

$$F ( w ) = ‖ Truth - diag ( D M * W ( w ) ) ‖ \qquad ( Eq . l )$$

$${min}_{w} F ( w )$$

where DM is the Data Matrix, w is scaling weights, W(w) is the weight matrix created by circular shifting the scaling weights vector.

Returning to the operations of the flowchart 900, after computing the set of scaling weights at block 904, operations of the flowchart 900 continue at block 906.

At block 906, a determination is made of whether the multiplication result (of multiplying the set of scaling weights with the original training data from the reference training data matrix) matches the reference training data matrix. For example, with reference to FIG. 1, the processor 188 may perform this determination. In some implementations, the processor 188 may make this determination based on whether the result of multiplying the set of scaling weights with the original training data is the same or substantially the same as the ideal response. For example, it may be considered a match between the two matrices if the difference between the optimized response and the ideal response are less than 1%, 5%, 10%, etc. If the multiplication result does not match the reference training data matrix, operations of the flowchart 900 return to block 904 to compute another set of scaling weights. Otherwise, if the multiplication result does match the reference training data matrix, operations of the flowchart continue at block 908.

At block 908, the excitations of one or more transmitter coils are adjusted according to the set of scaling weights. For example, with reference to FIG. 1, the processor 188 may make this adjustment based on instructions to a controller that is to control the excitations. In some implementations, the adjusting of the excitations may include adjusting at least one of the amplitude or the phase of one or more of the excitation signals. In some implementations, the set of scaling weights may be applied directly in the transmitters coils to adjust the excitation level and/or phase to focus the transmitted EM field in a preferred direction. In some implementations, this direction may be electronically rotated to scan all azimuths sequentially.

Operations of the flowchart 900 continue at transition point B, which continues at transition point B of the flowchart 800. From transition point B of the flowchart 800, operations continue at block 806, where the each of the transmitter coils emit an excitation signal independent of the other transmitter coils (as described above).

Operations for software-based focusing for azimuthal wellbore tubular defect evaluation of the flowchart 1000 are now described. Operations of the flowchart 1000 start at transition point C (from the transition point C of the flowchart 800). From the transition point C, operations continue at block 1002.

At block 1002, a reference training data matrix is received. For example, with reference to FIG. 1, the processor 188 may receive the reference training data matrix. This reference training matrix may be the same matrix used for hardware-based focusing (if such hardware-based focusing was performed).

At block 1004, a set of scaling weights is computed to multiply with original training data. For example, with reference to FIG. 1, the processor 188 may perform this computing of the set of scaling weights. In some implementations, the processor 188 may reuse the computed set of scaling weights that was computed as part of the hardware-based focusing (if such hardware-based focusing was performed).

At block 1006, a determination is made of whether the multiplication result (of multiplying the set of scaling weights with the original training data from the reference training data matrix) matches the reference training data matrix. For example, with reference to FIG. 1, the processor 188 may perform this determination. If the multiplication result does not match the reference training data matrix, operations of the flowchart 1000 return to block 1004 to compute another set of scaling weights. Otherwise, if the multiplication result does match the reference training data matrix, operations of the flowchart continue at block 1008.

At block 1008, the set of scaling weights is applied to the original data matrix (computed at block 810) to create a scaled data matrix. For example, with reference to FIG. 1, the processor 188 may perform this operation.

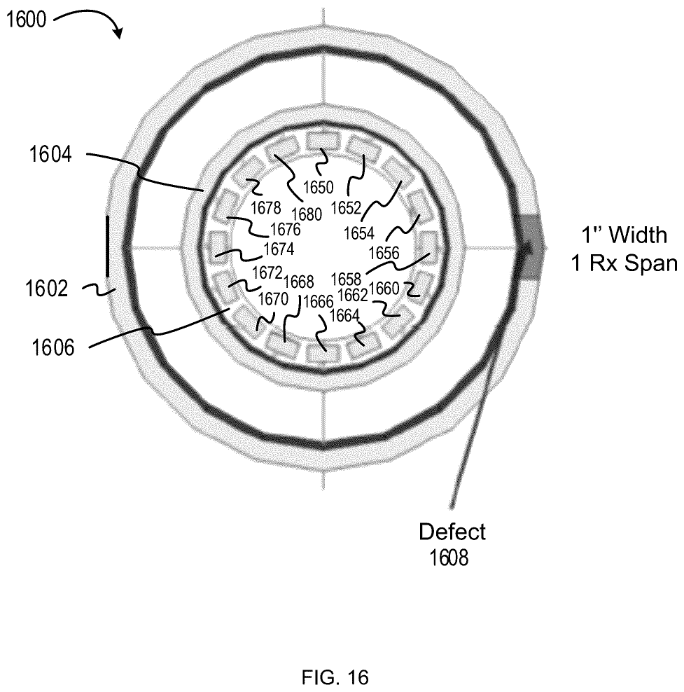

In some implementations, this software focusing to create a focused response (the scaled data matrix) may be applied to more challenging conditions, such as defects with of varying widths, defects that include holes in the wellbore tubular (e.g., the casing), etc. To illustrate, FIGS. 16-20 are cross-sectional top side views down into a wellbore, having a tool that includes a transmitter array with multiple transmitter coils positioned in multiple wellbore tubulars having a defect of varying widths, according to some embodiments.

FIG. 16 depicts a cross-sectional top view down into a wellbore 1600 having two wellbore tubulars (1602 and 1604). For example, the wellbore tubular 1602 may be casing, and the wellbore tubular 1604 may be production tubing. In this example, the wellbore tubular 1602 includes a defect 1608 having a width of one inch. FIG. 16 also includes a transmitter array 1606 (that is part of a downhole tool) that is positioned within both of the wellbore tubulars 1602 and 1604. In this example, the transmitter array 1606 includes 16 transmitter coils 1650-1680 (positioned at different azimuthal positions within the wellbore 1600). Also, in this example, the receiver span is one-corresponding to the defect 1608 having a width of one inch.

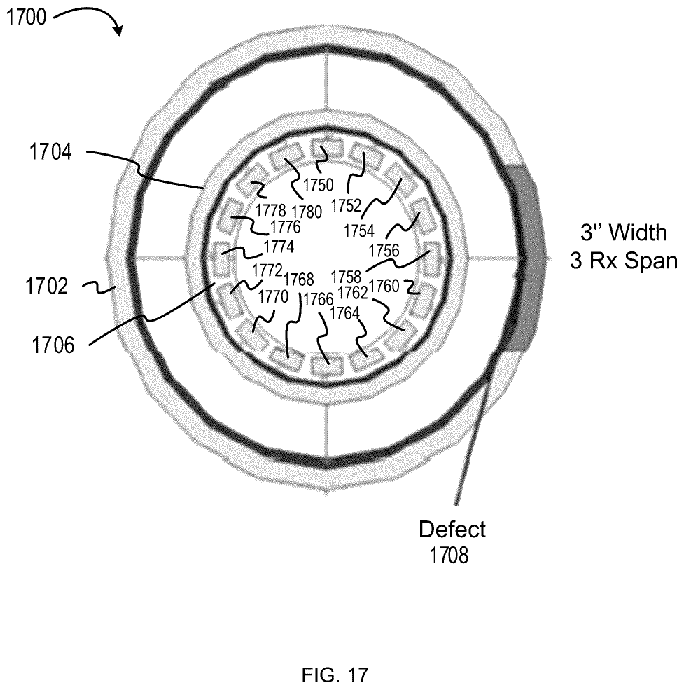

FIG. 17 depicts a cross-sectional top view down into a wellbore 1700 having two wellbore tubulars (1702 and 1704). For example, the wellbore tubular 1702 may be casing, and the wellbore tubular 1704 may be production tubing. In this example, the wellbore tubular 1702 includes a defect 1708 having a width of three inches. FIG. 17 also includes a transmitter array 1706 (that is part of a downhole tool) that is positioned within both of the wellbore tubulars 1702 and 1704. In this example, the transmitter array 1706 includes 16 transmitter coils 1750-1780 (positioned at different azimuthal positions within the wellbore 1700). Also, in this example, the receiver span is three-corresponding to the defect 1708 having a width of three inches.

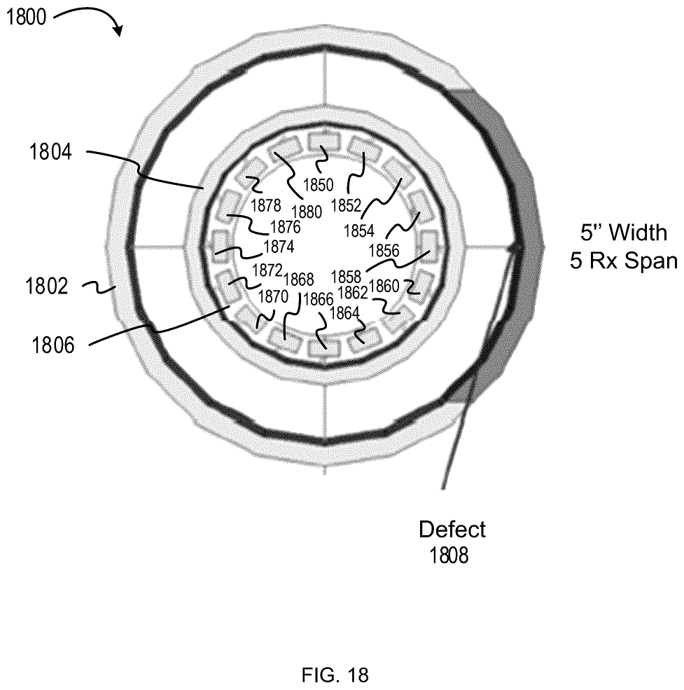

FIG. 18 depicts a cross-sectional top view down into a wellbore 1800 having two wellbore tubulars (1802 and 1804). For example, the wellbore tubular 1802 may be casing, and the wellbore tubular 1804 may be production tubing. In this example, the wellbore tubular 1802 includes a defect 1808 having a width of five inches. FIG. 18 also includes a transmitter array 1806 (that is part of a downhole tool) that is positioned within both of the wellbore tubulars 1802 and 1804. In this example, the transmitter array 1806 includes 16 transmitter coils 1850-1880 (positioned at different azimuthal positions within the wellbore 1800). Also, in this example, the receiver span is five—corresponding to the defect 1808 having a width of five inches.

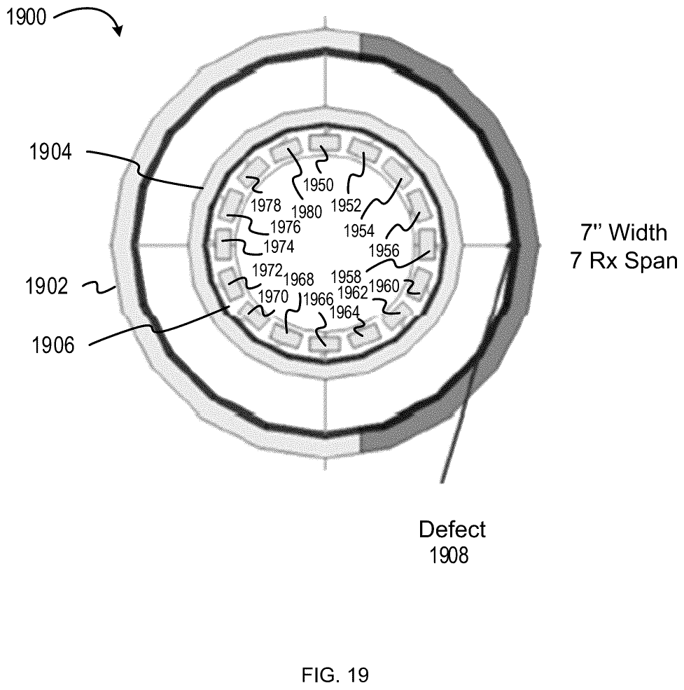

FIG. 19 depicts a cross-sectional top view down into a wellbore 1900 having two wellbore tubulars (1902 and 1904). For example, the wellbore tubular 1902 may be casing, and the wellbore tubular 1904 may be production tubing. In this example, the wellbore tubular 1902 includes a defect 1908 having a width of seven inches. FIG. 19 also includes a transmitter array 1906 (that is part of a downhole tool) that is positioned within both of the wellbore tubulars 1902 and 1904. In this example, the transmitter array 1906 includes 16 transmitter coils 1950-1980 (positioned at different azimuthal positions within the wellbore 1900). Also, in this example, the receiver span is seven-corresponding to the defect 1908 having a width of seven inches.

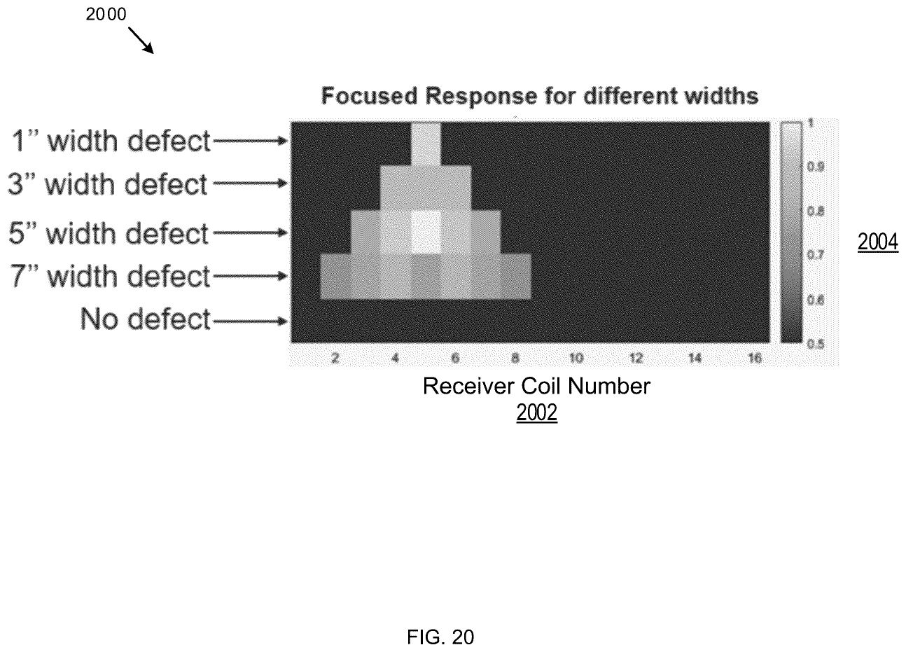

FIG. 20 is a plot of an example focused response after software focusing via signal processing of the defects of varying widths of FIGS. 16-19, according to some embodiments. In FIG. 20, a plot 2000 includes an x-axis 2002 that includes a column for each of the 16 receiver coils (1-16) and a y-axis 2004 that includes a likelihood of a defect. The plot 2000 also includes different blocks at the intersections between a given receiver coil and likelihood of a defect. The lighter the block the higher likelihood that there is a defect.

In this example, a one inch defect (associated with the example of FIG. 16) is depicted in the top row and azimuthally this one inch defect is at or near the receiver coil #5. A three inch defect (associated with the example of FIG. 17) is depicted in the row below and azimuthally this three inch defect at or near the receiver coils #4-6. A five inch defect (associated with the example of FIG. 18) is depicted in the row below and azimuthally this five inch defect at or near the receiver coils #3-7. A seven inch defect (associated with the example of FIG. 19) is depicted in the row below and azimuthally this seven inch defect at or near the receiver coils #2-8. The row below is an example of no defect.

As shown, the plot 2000 allows a visual comparison among defects of varying widths. In some implementations, a same set of scaling weights may be applied across different widths of defects. Accordingly, after a set of scaling weights is computed for a given width (e.g., one inch) defect, these same set of scaling weights may be reused for defects of other widths (e.g., three inch, five inch, seven inch, etc.). Therefore, there is no requirement for a set of scaling weights to be computed for each defect of differing widths. Thus, there is no need to know the width and/or location of any defects in order to compute the set of scaling weights. Using the same set of scaling weights for different widths of defects may not necessarily optimize for a defect for each width. However, using the same set of scaling weights independent of the width of the defect allows for computation of the set of scaling weights without knowing the width and/or location of the defect. This is illustrated by the plot of 2000. In this example, the set of scaling weights is computed based on the one inch defect, which is shown as a lightest shading (indicative of most likely a defect). As shown, the shading for the three inch, five inch, and seven inches are less light because the set of scaling weights for the one inch defect are used for these larger defects.

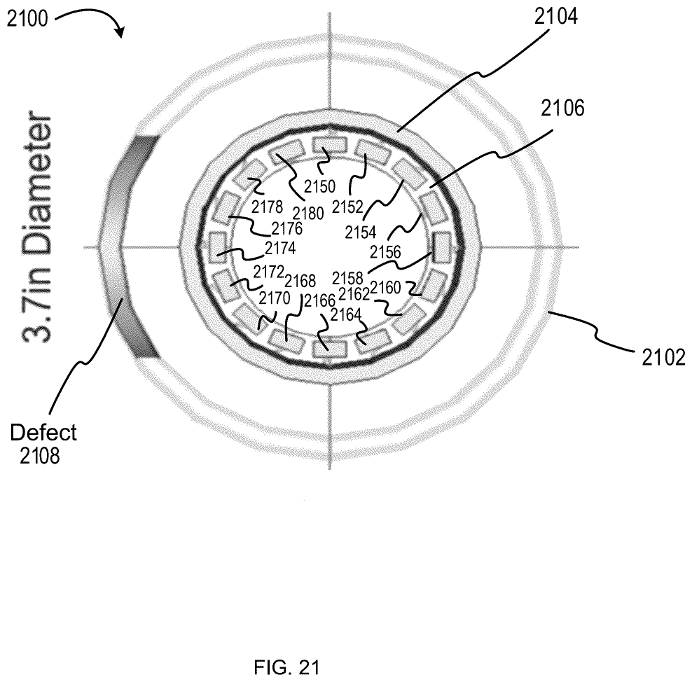

Another example challenging condition (a hole (not a slot) in the casing through production tubing) for defect detection for software focusing to create a focused response is now described. In particular, FIG. 21 is a cross-sectional top side view down into a wellbore, having a tool that includes a transmitter array with multiple transmitter coils positioned in a production tubing that is within a casing having a defect that is a hole, according to some embodiments.

FIG. 21 depicts a cross-sectional top view down into a wellbore 2100 having two wellbore tubulars (2102 and 2104). For example, the wellbore tubular 2102 may be casing, and the wellbore tubular 2104 may be production tubing. In this example, the wellbore tubular 2102 includes a defect 2108 that is a hole. FIG. 21 also includes a transmitter array 2106 (that is part of a downhole tool) that is positioned within both of the wellbore tubulars 2102 and 2104. In this example, the transmitter array 2106 includes 16 transmitter coils 2150-2180 (positioned at different azimuthal positions within the wellbore 2100).

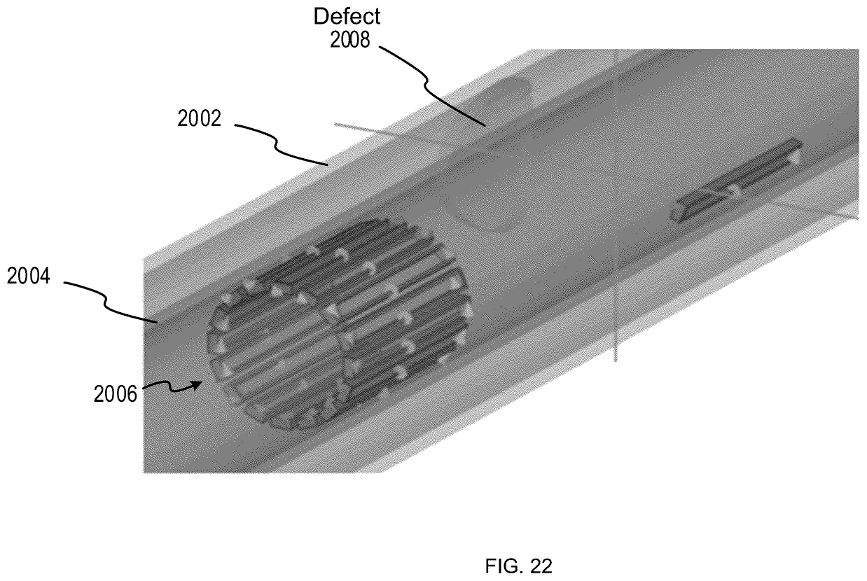

FIG. 22 is a perspective view of a portion of casing and production tubing of FIG. 21, according to some embodiments. FIG. 22 depicts the casing 2102 with the production tubing 2104 positioned therein. FIG. 22 also depicts the transmitter array 2106 positioned within the production tubing 2104. The defect 2108 is depicted as a hole in the casing 2102.

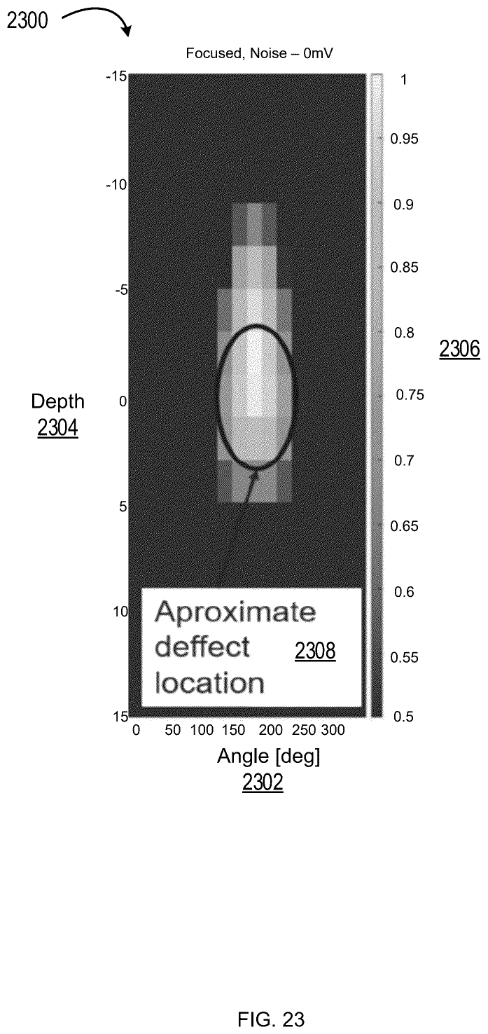

FIG. 23 is a plot of an example focused response after software focusing via signal processing of the defect (a hole in the casing) of FIGS. 21-22, according to some embodiments. In FIG. 23, a plot 2300 includes an x-axis 2302 that includes that is the azimuthal direction having ranges of 0-360 degrees and a y-axis 2304 that is a depth of the tool in the wellbore with respective a given reference depth in the wellbore. A scale 2306 is the likelihood of a defect based on the shading. The lighter the shading of a block in the plot 2300 the higher likelihood that there is a defect. In this example, the plot 2300 includes an approximate defect location 2308.

Returning to the operations of the flowchart 1000 at FIG. 10, operations continue from block 1008 to the operations at block 1010.

At block 1010, the data matrix (created at block 810) is replaced with the scaled data matrix. For example, with reference to FIG. 1, the processor 188 may perform this operation.

Operations of the flowchart 1000 continue at transition point D, which continues at transition point D of the flowchart 800. From transition point B of the flowchart 800, operations continue at block 806, where a determination of whether there are any defects in the wellbore tubular based on the scaled data matrix.

b. Radial Depth Focusing Wellbore Tubular Defect Evaluation

Example operations for radial depth focusing wellbore tubular defect evaluation are now described. For example, a similar procedure used in software and hardware focusing to create a set of weights to combine the data matrix into a single focused response for the casing string (see description of FIGS. 8-10) may also be used to create an optimal set of weights for the tubing string. For example, an additional step may modify the optimization strategy to at the same time focus on casing and defocus on tubing and vice-versa. With such operations, it is possible to create a workflow for radial depth focusing as well as azimuthal focusing. Such focusing/defocusing may create undesired artifacts on the final individual responses. Such artifacts may be suppressed by doing a combination using different extractions of the raw data matrix, together with focused response in relation to rows and columns of the data matrix.

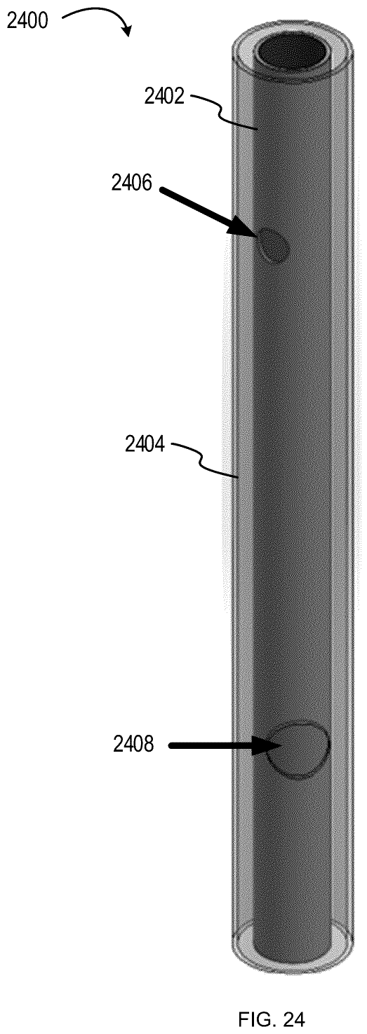

To help illustrate, FIG. 24 is a perspective view of example nested wellbore tubulars that includes an inner tubing positioned with a casing (each having a defect), according to some embodiments. FIG. 24 depicts nested wellbore tubulars 2400 that includes a casing 2404 and a tubing 2402 (also referenced as an inner tubing) positioned within the casing 2404. The nested wellbore tubulars 2400 may be positioned downhole in a wellbore. For example, with reference to FIG. 1, the nested wellbore tubulars 2400 may be positioned in the wellbore 104. The casing 2404 and the tubing 2402 are at different radial depths. In this example, a radial depth of the casing 2404 is greater than a radial depth of the tubing 2402. Also in this example, the casing 2404 has a defect 2408, and the tubing 2402 has a defect 2406.

As further described below, there may be different sets of weights for focusing the data for the defect being detected. In some implementations, each set of weights may be for a different radial depth in the wellbore. For example, a first set of weights may be for a radial depth for the casing 2404, and a second set of weights may be for a radial depth for the tubing 2402. Accordingly, the first set of weights may be used to detect defects (such as the defect 2408) in the casing 2404, while the second set of weights may be used to detect defects (such as the defect 2406) in the tubing 2402.

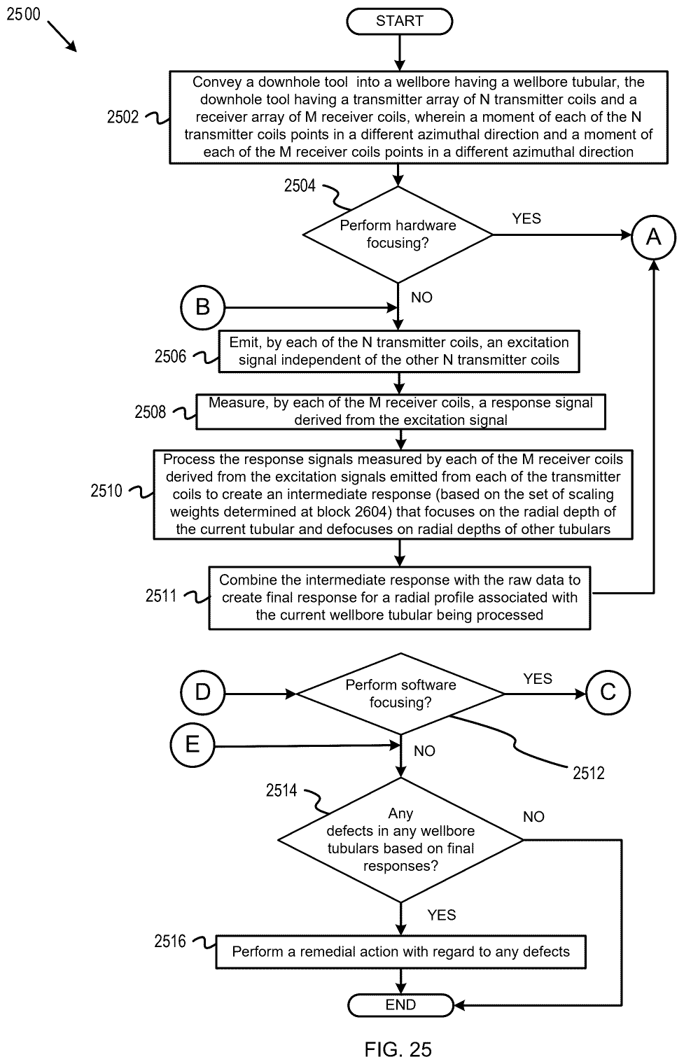

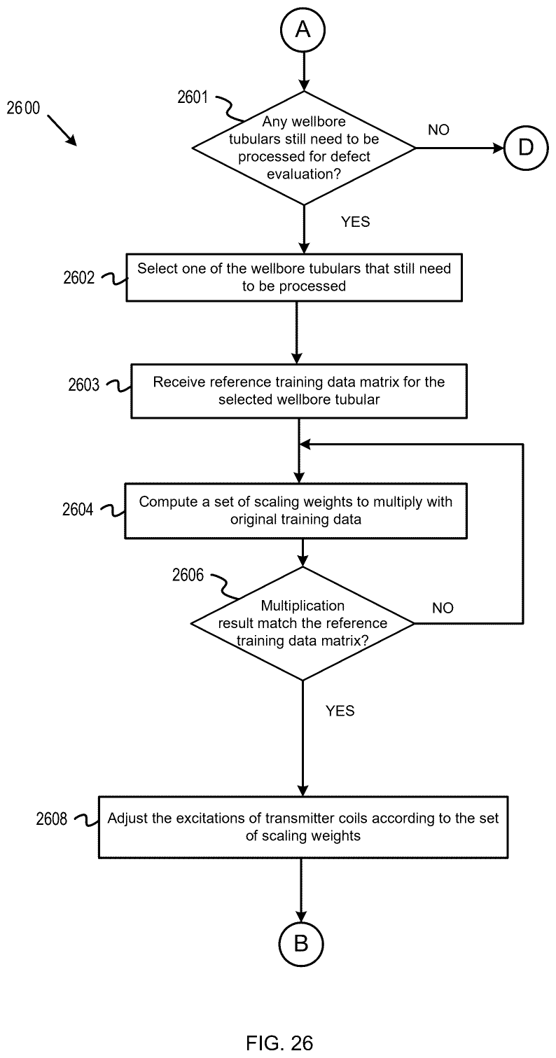

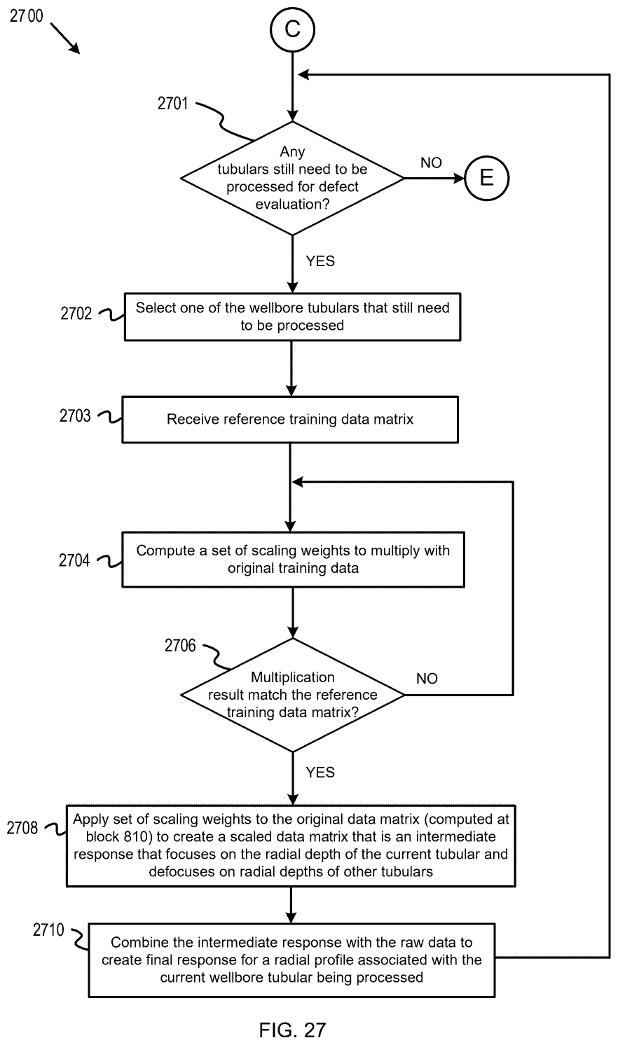

Example operations for radial depth focusing wellbore tubular defect evaluation are now described with reference to flowcharts of FIGS. 25-27. FIG. 25 is a block diagram of a flowchart of example operations for performing radial depth focusing wellbore tubular defect evaluation, according to some embodiments. FIG. 26 is a block diagram of a flowchart of example operations for hardware-based radial depth focusing wellbore tubular defect evaluation, according to some embodiments. FIG. 27 is a block diagram of a flowchart of example operations for software-based radial depth focusing wellbore tubular defect evaluation, according to some embodiments.

Operations of flowcharts 2500, 2600, and 2700 of FIGS. 25-27, respectively, may be performed by software, firmware, hardware, or a combination thereof. Operations of the flowcharts 2500-2700 continue among each other through transition points A, B, C, D, and E. Operations of the flowcharts 2500-2700 are described in reference to FIGS. 1-2. However, other systems and components can be used to perform the operations now described. Operations of the flowchart 2500 start at block 2502.

At block 2502, a downhole tool is conveyed into a wellbore having a wellbore tubular. For example, with reference to FIG. 2, the downhole tool 200 may include the transmitter array 204 of N transmitter coils and the receiver array 202 of M receiver coils. In some implementations, a moment of each of the N transmitter coils may point in a different azimuthal direction and a moment of each of the M receiver coils may point in a different azimuthal direction. With reference to FIG. 1, the downhole tool 114 may be conveyed down the wellbore 104 into one or more wellbore tubulars. For example, the downhole tool 114 may be lowered into a production tubing that includes a casing around the wellbore 104. The downhole tool 114 may be used to detect defects of a wellbore tubular at different depths of the wellbore 104.

At block 2504, a determination is made of whether hardware focusing for radial depth wellbore tubular defect evaluation is to be performed. For example, with reference to FIG. 1, the processor 188 may make this determination. In some implementations this determination may be based on a control setting, the type of wellbore that was drilled, the type of wellbore tubulars on which defect evaluation is performed, the type of subsurface formation into which the wellbore is formed, etc. If it is determined that hardware focusing is to be performed, operations of the flowchart 2500 continue at transition point A, which continues at transition point A of the flowchart 2600 (which is further described below). Otherwise, operations of the flowchart 2500 continue at block 2506.

At block 2506, each of the N transmitter coils emit an excitation signal independent of the other N transmitter coils. For example, with reference to FIG. 2, each of the N transmitter coils 250-280 of the transmitter array 204 may emit an excitation signal independent of the other transmitter coils of the transmitter array 204.

At block 2508, each of the M receiver coils measures a response signal derived from each of the excitation signals. For example, with reference to FIG. 2, each of the M receiver coils 210-240 of the receiver array 202 may measure a response signal derived from each excitation signal emitted by each of the transmitter coils 250-280 of the receiver array 202.

This measured data may be plotted in a data matrix. For example, with reference to FIG. 1, the processor 188 may process the response signals such that the measured data is plotted in a data matrix. For instance, with reference to FIG. 11, the processor 188 may create the plot 1100 (a raw data matrix of the raw data) (as described above).

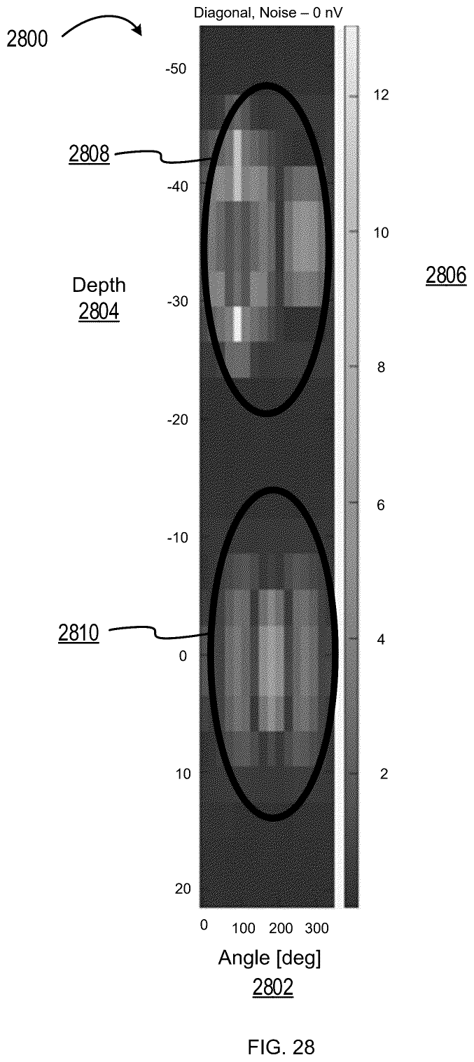

Additionally, three different plots may be extracted from the raw data matrix. For example, with reference to the nested wellbore tubulars 2400 of FIG. 24, three different plots may be derived from the raw data (the plots depicted in FIGS. 28-30). As further described below, each of the three different plots include an approximate defect location associated with the defect 2406 in the tubing 2402 and the defect 2408 in the casing 2404.

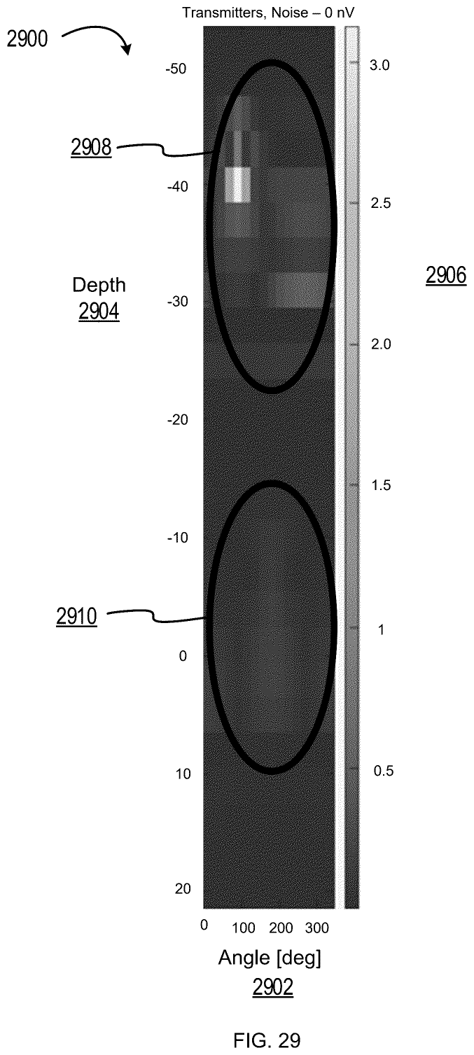

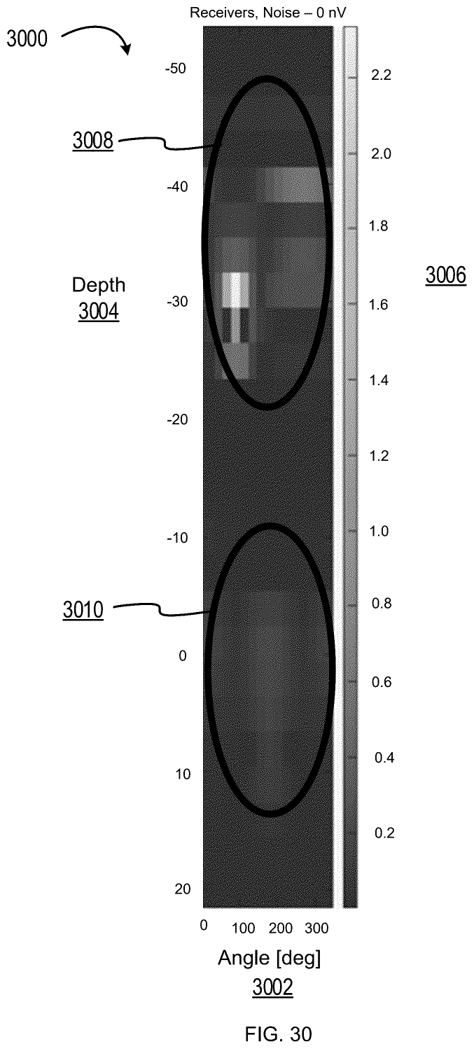

In particular, FIG. 28 is a plot of the data extracted from the diagonals of a raw data matrix, respectively, according to some embodiments. FIG. 29 is a plot of the data extracted from the transmitters of a raw data matrix, respectively, according to some embodiments. FIG. 30 is a plot of the data extracted from the receivers of a raw data matrix, respectively, according to some embodiments. The three plots depicted in FIGS. 28-30 may be derived from the three components of the data matrix depicted in the plot 1100 of FIG. 11.

In FIG. 28, a plot 2800 may be derived from the diagonals of the data matrix depicted in the plot 1100 of FIG. 11. The plot 2800 includes an x-axis 2802 that includes that is the azimuthal direction having ranges of 0-360 degrees and a y-axis 2804 that is a depth of the tool in the wellbore with respective a given reference depth in the wellbore. A scale 2806 is the likelihood of a defect based on the shading. The lighter the shading of a block in the plot 2800 the higher likelihood that there is a defect. In this example, the plot 2800 includes two approximate defect locations 2808 and 2810. The defect location 2808 corresponds to the defect 2406 in the tubing 2402 in FIG. 24. The defect location 2810 corresponds to the defect 2408 in the tubing 2404 in FIG. 24.

In FIG. 29, a plot 2900 may be derived from the columns (representing the transmitters) of the data matrix depicted in the plot 1100 of FIG. 11. The plot 2900 includes an x-axis 2902 that includes that is the azimuthal direction having ranges of 0-360 degrees and a y-axis 2904 that is a depth of the tool in the wellbore with respective a given reference depth in the wellbore. A scale 2906 is the likelihood of a defect based on the shading. The lighter the shading of a block in the plot 2900 the higher likelihood that there is a defect. In this example, the plot 2900 includes two approximate defect locations 2908 and 2910. The defect location 2908 corresponds to the defect 2406 in the tubing 2402 in FIG. 24. The defect location 2910 corresponds to the defect 2408 in the tubing 2404 in FIG. 24.

In FIG. 30, a plot 3000 may be derived from the rows (representing the receivers) of the data matrix depicted in the plot 1100 of FIG. 11. The plot 3000 includes an x-axis 3002 that includes that is the azimuthal direction having ranges of 0-360 degrees and a y-axis 3004 that is a depth of the tool in the wellbore with respective a given reference depth in the wellbore. A scale 3006 is the likelihood of a defect based on the shading. The lighter the shading of a block in the plot 3000 the higher likelihood that there is a defect. In this example, the plot 3000 includes two approximate defect locations 3008 and 3010. The defect location 3008 corresponds to the defect 2406 in the tubing 2402 in FIG. 24. The defect location 3010 corresponds to the defect 2408 in the tubing 2404 in FIG. 24.

Returning to the operations of the flowchart 2500 of FIG. 25, operations continue at block 2510.

At block 2510, the response signals measured by each of the M receiver coils derived from the excitation signals emitted from each of the transmitter coils are processed to create an intermediate response (based on the set of scaling weights determined at block 2604—further described below) that focuses on the radial depth of the current tubular and defocuses on radial depths of other tubulars. For example, with reference to FIG. 1, the processor 188 may perform this operation.

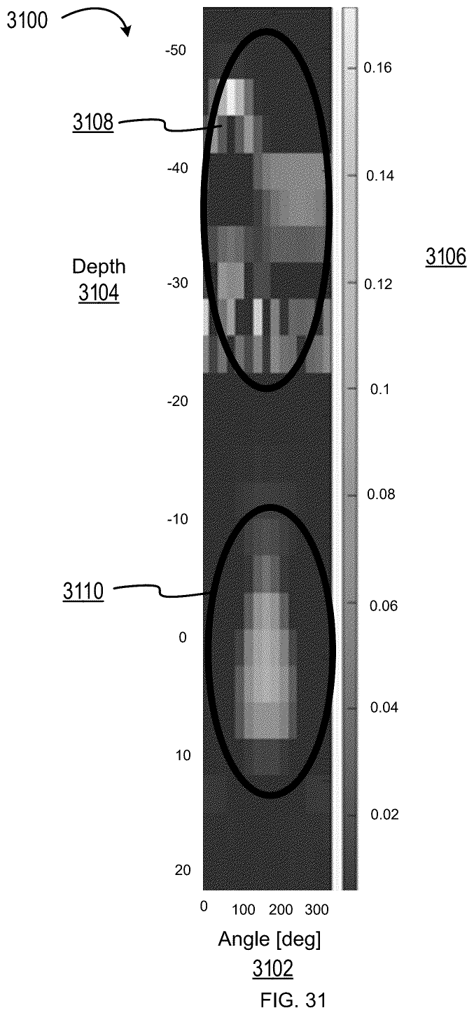

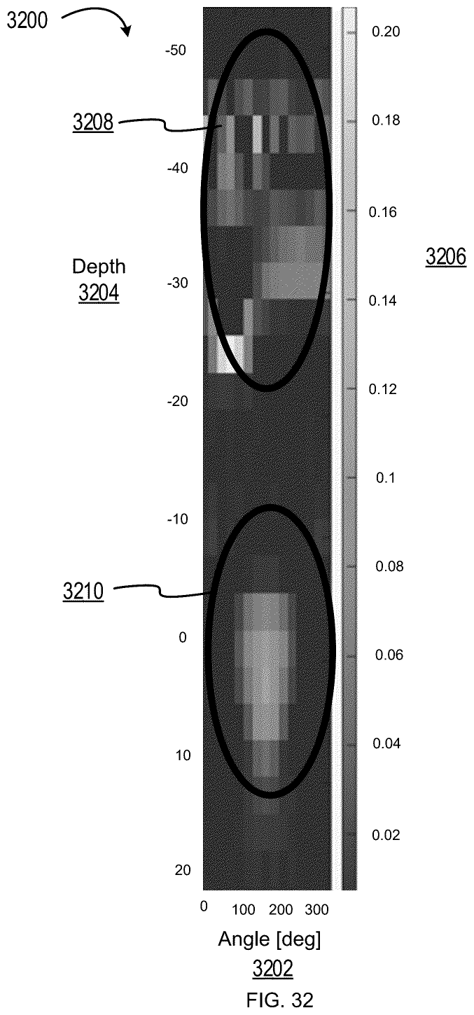

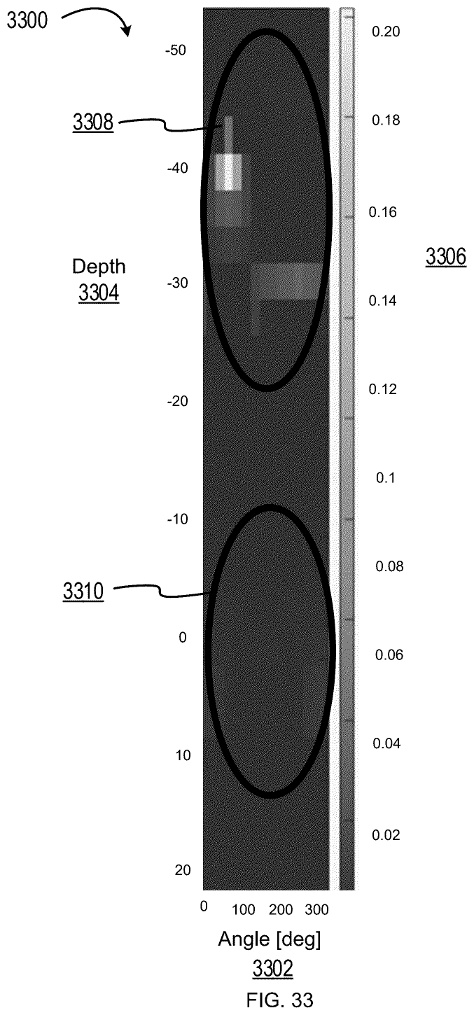

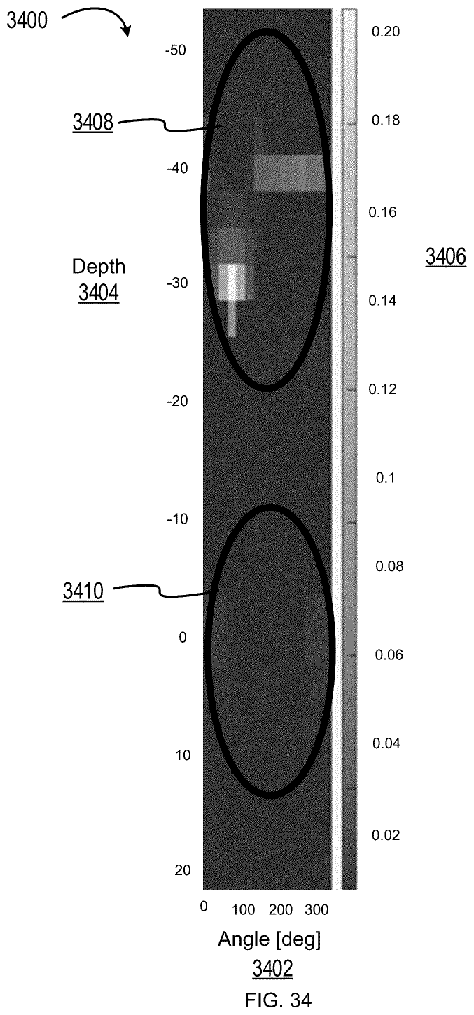

For example, the processor 188 may multiply the raw data depicted in the three plots 2900-3000 of FIGS. 29-30 by the set of scaling weights to create intermediate responses. To illustrate, a first set of example intermediate responses is depicted by plots in FIGS. 31-32 for a first wellbore tubular at a first radial depth (such as the casing 2404 of FIG. 24). A second set of example intermediate responses is depicted by plots in FIGS. 33-34 for a second wellbore tubular at a second radial depth (such as the tubing 2402 of FIG. 24).

FIGS. 31-32 include intermediate responses focusing on the casing and defocusing on the inner tubing. The intermediate responses of FIGS. 31-32 using a same set of scaling weights that focus on the casing. The intermediate response of FIG. 31 focuses on data from the receivers. In contrast, the intermediate response of FIG. 32 focuses on data from the transmitters.

FIGS. 33-34 include intermediate responses focusing on the inner tubing and defocusing on the casing. The intermediate responses of FIGS. 33-34 using a same set of scaling weights that focus on the inner tubing. The intermediate response of FIG. 31 focuses on data from the receivers. In contrast, the intermediate response of FIG. 32 focuses on data from the transmitters.

In particular, FIG. 31 is a plot of an intermediate response from a set of scaling weights obtained based on focusing on the casing and defocusing on the inner tubing applied to the raw data of FIG. 30 (derived from the rows (the receivers) of the raw data matrix), according to some embodiments. In FIG. 31, a plot 3100 may be derived from multiplying the selected set of scaling weights obtained based on focusing on the casing and defocusing on the inner tubing applied to the raw data of FIG. 30. The plot 3100 is emphasizing more on the data from the receivers (instead of data from the transmitters). The plot 3100 includes an x-axis 3102 that includes that is the azimuthal direction having ranges of 0-360 degrees and a y-axis 3104 that is a depth of the tool in the wellbore with respective a given reference depth in the wellbore. A scale 3106 is the likelihood of a defect based on the shading. The lighter the shading of a block in the plot 3100 the higher likelihood that there is a defect. In this example, the plot 3100 includes two approximate defect locations 3108 and 3110. The defect location 3108 corresponds to the defect 2406 in the tubing 2402 in FIG. 24. The defect location 3110 corresponds to the defect 2408 in the tubing 2404 in FIG. 24.

FIG. 32 is a plot of an intermediate response from a set of scaling weights obtained based on focusing on the casing and defocusing on the inner tubing applied to the raw data of FIG. 29 (derived from the columns (the transmitters) of the raw data matrix), according to some embodiments. In FIG. 32, a plot 3200 may be derived from multiplying the selected set of scaling weights obtained based on focusing on the casing and defocusing on the inner tubing applied to the raw data of FIG. 29. The plot 3200 is emphasizing more on the data from the transmitters (instead of data from the receivers). The plot 3200 includes an x-axis 3202 that includes that is the azimuthal direction having ranges of 0-360 degrees and a y-axis 3204 that is a depth of the tool in the wellbore with respective a given reference depth in the wellbore. A scale 3206 is the likelihood of a defect based on the shading. The lighter the shading of a block in the plot 3200 the higher likelihood that there is a defect. In this example, the plot 3200 includes two approximate defect locations 3208 and 3210. The defect location 3208 corresponds to the defect 2406 in the tubing 2402 in FIG. 24. The defect location 3210 corresponds to the defect 2408 in the tubing 2404 in FIG. 24.

FIG. 33 is a plot of an intermediate response from a set of scaling weights obtained based on focusing on the inner tubing and defocusing on the casing applied to the raw data of FIG. 30 (derived from the rows (the receivers) of the raw data matrix), according to some embodiments. In FIG. 33, a plot 3300 may be derived from multiplying the selected set of scaling weights obtained based on focusing on the inner tubing and defocusing on the casing applied to the raw data of FIG. 29. The plot 3300 includes an x-axis 3302 that includes that is the azimuthal direction having ranges of 0-360 degrees and a y-axis 3304 that is a depth of the tool in the wellbore with respective a given reference depth in the wellbore. A scale 3306 is the likelihood of a defect based on the shading. The lighter the shading of a block in the plot 3300 the higher likelihood that there is a defect. In this example, the plot 3300 includes two approximate defect locations 3308 and 3310. The defect location 3308 corresponds to the defect 2406 in the tubing 2402 in FIG. 24. The defect location 3310 corresponds to the defect 2408 in the tubing 2404 in FIG. 24.

FIG. 34 is a plot of an intermediate response from a set of scaling weights obtained based on focusing on the inner tubing and defocusing on the casing applied to the raw data of FIG. 29 (derived from the columns (the transmitters) of the raw data matrix), according to some embodiments. The plot 3400 includes an x-axis 3402 that includes that is the azimuthal direction having ranges of 0-360 degrees and a y-axis 3404 that is a depth of the tool in the wellbore with respective a given reference depth in the wellbore. A scale 3406 is the likelihood of a defect based on the shading. The lighter the shading of a block in the plot 3400 the higher likelihood that there is a defect. In this example, the plot 3400 includes two approximate defect locations 3408 and 3410. The defect location 3408 corresponds to the defect 2406 in the tubing 2402 in FIG. 24. The defect location 3410 corresponds to the defect 2408 in the tubing 2404 in FIG. 24.

Returning to FIG. 25, operations of the flowchart 2500 continue at block 2511.

At block 2511, the intermediate response is combined with the raw data to create a final response for a radial profile associated with the current tubular being processed. For example, with reference to FIG. 1, the processor 188 may perform this operation.

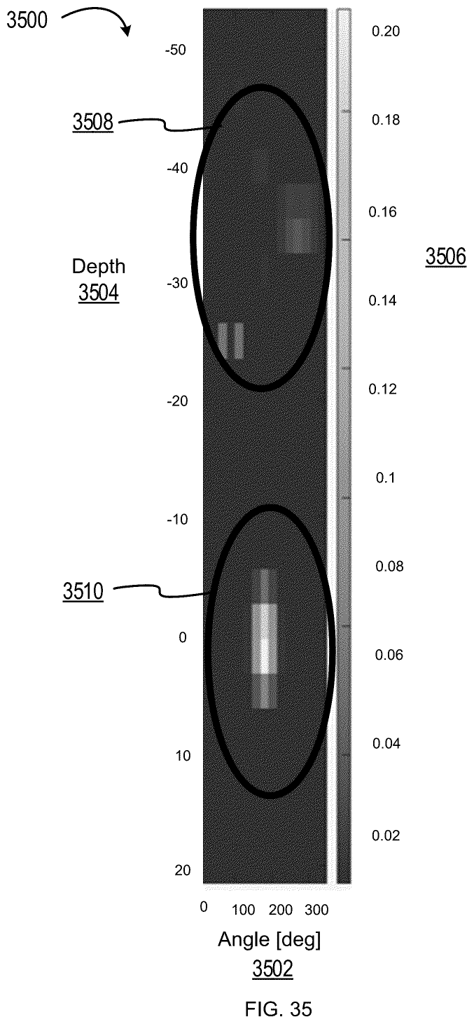

To illustrate, FIG. 35 is a plot of a final casing response that focuses on the casing and defocuses on the inner tubing using a first radial profile starting from a same data matrix, according to some embodiments. In FIG. 35, a plot 3500 may be derived by combining the intermediate responses for the casing (see plots 3100 and 3200 of FIGS. 31-32, respectively) with the raw data (see plots 2800, 2900, and 3000 of FIGS. 28-30, respectively). For example, intermediate responses for the casing may be combined with the raw data by multiplication. The plot 3500 includes an x-axis 3502 that includes that is the azimuthal direction having ranges of 0-360 degrees and a y-axis 3504 that is a depth of the tool in the wellbore with respective a given reference depth in the wellbore. A scale 3506 is the likelihood of a defect based on the shading. The lighter the shading of a block in the plot 3500 the higher likelihood that there is a defect. In this example, the plot 3500 includes a defect location 3510 corresponds to the defect 2408 in the tubing 2404 in FIG. 24. A location 3508 is a location that was previously a defect location from the tubing that that has been removed/reduced. Accordingly, such combining of the intermediate responses with the raw data may provide a filtering such that the final response for the casing includes any defects in the casing while having no or limited artifacts (false positives) for the defects of the inner tubing.

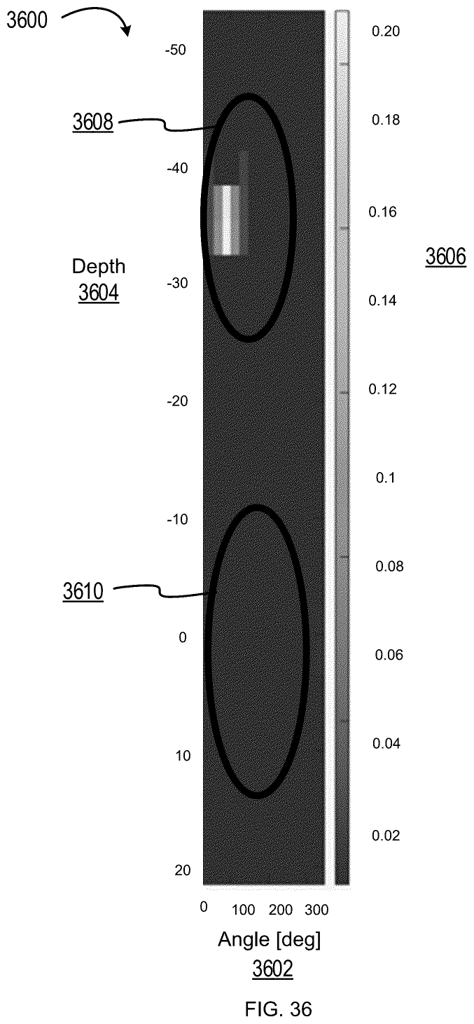

FIG. 36 is a plot of a final inner tubing response that focuses on the inner tubing and defocuses on the casing using a second radial profile starting from the same data matrix, according to some embodiments. In FIG. 36, a plot 3600 may be derived by combining the intermediate responses for the inner tubing (see plots 3300 and 3400 of FIGS. 33-34, respectively) with the raw data (see plots 2800, 2900, and 3000 of FIGS. 28-30, respectively). For example, intermediate responses for the inner tubing may be combined with the raw data by multiplication. The plot 3600 includes an x-axis 3602 that includes that is the azimuthal direction having ranges of 0-360 degrees and a y-axis 3604 that is a depth of the tool in the wellbore with respective a given reference depth in the wellbore. A scale 3606 is the likelihood of a defect based on the shading. The lighter the shading of a block in the plot 3600 the higher likelihood that there is a defect. In this example, the plot 3600 includes a defect location 3608 corresponds to the defect 2406 in the tubing 2402 in FIG. 24. A location 3610 is a location that was previously a defect location from the casing that that has been removed/reduced. Accordingly, such combining of the intermediate responses with the raw data may provide a filtering such that the final response for the inner tubing includes any defects in the inner tubing while having no or limited artifacts (false positives) for the defects of the casing.

Returning to the operations of the flowchart 2500, a transition point D is originating from a transition point D of the flowchart 2600 (which is further described below). From transition point D, operations of the flowchart 2500 continue at block 2512.

At block 2512, a determination is made of whether software focusing for radial depth wellbore tubular defect evaluation is to be performed. For example, with reference to FIG. 1, the processor 188 may make this determination. In some implementations this determination may be based on a control setting, the type of wellbore that was drilled, the type of wellbore tubulars on which defect evaluation is performed, the type of subsurface formation into which the wellbore is formed, etc. If it is determined that software focusing is to be performed, operations of the flowchart 2500 continue at transition point C, which continues at transition point C of the flowchart 1000 (which is further described below). Otherwise, operations of the flowchart 2500 continue at block 2514.

At block 2514, a determination is made of whether there are any defects detected in any of the wellbore tubulars (e.g., casing, inner tubing, etc.) based on the final responses for the different wellbore tubulars. For example, with reference to FIG. 1, the processor 188 may make this determination. If there are no defects detected in any of the wellbore tubulars, operations of the flowchart 2500 are complete. Otherwise, operations of the flowchart 2500 continue at block 2516.

At block 2516, a remedial action with regard to any defects is performed. For example, the remedial action may include at least one of repairing or replacing a section of the wellbore tubular with a defect. Additionally, the severity, number, location, etc. of defects may determine the type of remedial action. For example, if there is a single minor defect, this section of the wellbore tubular may be repaired. In another example, if there are numerous and/or severe defects, this section of the wellbore tubular may be replaced. Operations of the flowchart 2500 are complete.

Operations for hardware-based focusing for radial depth wellbore tubular defect evaluation of the flowchart 2600 are now described. Operations of the flowchart 2600 start at transition point A (from the transition point A of the flowchart 2500). From the transition point A, operations continue at block 2601.

At block 2601, a determination is made of whether there are any wellbore tubulars that still need to be processed for defect evaluation. For example, with reference to FIG. 1, the processor 188 may make this determination. For instance, with reference to FIG. 24, there are two wellbore tubulars that need to be processed—the inner tubing 2402 and the casing 2404. If there are no wellbore tubulars that still need to be processed, operations of the flowchart 2600 continue at transition point D, which continues at transition point D of the flowchart 2500 of FIG. 25. However, if there are any wellbore tubular that still need to be processed for defect evaluation, operations of the flowchart 2600 continue at block 2602.

At block 2602, one of the wellbore tubulars that still need to be processed is selected. For example, with reference to FIG. 1, the processor 188 may perform this selection. For instance, with reference to FIG. 24, if the casing 2404 has already been processed, the processor 188 would select the inner tubing 2402 to be processed.

At block 2603, a reference training data matrix for the selected wellbore tubular is received. For example, with reference to FIG. 1, the processor 188 may receive the reference training data matrix. In some implementations, the reference training data matrix may be created based on simulations or actual data of similar environments (such as similar types of wellbore tubulars, the nesting of the wellbore tubulars, etc.). See description of operations at block 902 of FIG. 9 above.

At block 2604, a set of scaling weights is computed to multiply with original training data. For example, with reference to FIG. 1, the processor 188 may perform this computing of the set of scaling weights. The original training data may be the data used to derive the reference training data matrix. See description of operations at block 904 of FIG. 9 above.

At block 2606, a determination is made of whether the multiplication result (of multiplying the set of scaling weights with the original training data from the reference training data matrix) matches the reference training data matrix. For example, with reference to FIG. 1, the processor 188 may perform this determination. In some implementations, the processor 188 may make this determination based on whether the result of multiplying the set of scaling weights with the original training data is the same or substantially the same as the ideal response. For example, it may be considered a match between the two matrices if the difference between the optimized response and the ideal response are less than 1%, 5%, 10%, etc. If the multiplication result does not match the reference training data matrix, operations of the flowchart 2600 return to block 2604 to compute another set of scaling weights. Otherwise, if the multiplication result does match the reference training data matrix, operations of the flowchart continue at block 2608.

At block 2608, the excitations of one or more transmitter coils are adjusted according to the set of scaling weights. For example, with reference to FIG. 1, the processor 188 may make this adjustment based on instructions to a controller that is to control the excitations. In some implementations, the adjusting of the excitations may include adjusting at least one of the amplitude or the phase of one or more of the excitation signals. In some implementations, the set of scaling weights may be applied directly in the transmitters coils to adjust the excitation level and/or phase to focus the transmitted EM field in a preferred direction. In some implementations, this direction may be electronically rotated to scan all azimuths sequentially.

Operations of the flowchart 2600 continue at transition point B, which continues at transition point B of the flowchart 2500. From transition point B of the flowchart 2500, operations continue at block 2506, where the each of the transmitter coils emit an excitation signal independent of the other transmitter coils (as described above).

Operations for software-based focusing for radial depth wellbore tubular defect evaluation of the flowchart 2700 are now described. Operations of the flowchart 2700 start at transition point C (from the transition point C of the flowchart 800). From the transition point C, operations continue at block 2701.

At block 2701, a determination is made of whether there are any wellbore tubulars that still need to be processed for defect evaluation. For example, with reference to FIG. 1, the processor 188 may make this determination. For instance, with reference to FIG. 24, there are two wellbore tubulars that need to be processed—the inner tubing 2402 and the casing 2404. If there are no wellbore tubulars that still need to be processed, operations of the flowchart 2700 continue at transition point E, which continues at transition point E of the flowchart 2500 of FIG. 25. However, if there are any wellbore tubular that still need to be processed for defect evaluation, operations of the flowchart 2700 continue at block 2702.

At block 2702, one of the wellbore tubulars that still need to be processed is selected. For example, with reference to FIG. 1, the processor 188 may perform this selection. For instance, with reference to FIG. 24, if the casing 2404 has already been processed, the processor 188 would select the inner tubing 2402 to be processed.

At block 2703, a reference training data matrix is received. For example, with reference to FIG. 1, the processor 188 may receive the reference training data matrix. This reference training matrix may be the same matrix used for hardware-based focusing (if such hardware-based focusing was performed).

At block 2704, a set of scaling weights is computed to multiply with original training data. For example, with reference to FIG. 1, the processor 188 may perform this computing of the set of scaling weights. In some implementations, the processor 188 may reuse the computed set of scaling weights that was computed as part of the hardware-based focusing (if such hardware-based focusing was performed).

At block 2706, a determination is made of whether the multiplication result (of multiplying the set of scaling weights with the original training data from the reference training data matrix) matches the reference training data matrix. For example, with reference to FIG. 1, the processor 188 may perform this determination. If the multiplication result does not match the reference training data matrix, operations of the flowchart 2700 return to block 2704 to compute another set of scaling weights. Otherwise, if the multiplication result does match the reference training data matrix, operations of the flowchart continue at block 2708.

At block 2708, the set of scaling weights is applied to the original data matrix (computed at block 810) to create a scaled data matrix that is an intermediate response that focuses on the radial depth of the current tubular and defocuses on radial depths of other tubulars. For example, with reference to FIG. 1, the processor 188 may perform this operation. For instance, see the description of the operations at block 2510 of FIG. 25 above.

At block 2710, the intermediate response is combined with the raw data to create final response for a radial profile associated with the current wellbore tubular being processed. For example, with reference to FIG. 1, the processor 188 may perform this operation. For instance, see the description of the operations at block 2511 of FIG. 25 above.

Operations of the flowchart 2700 return to block 2701 to determine if any other tubulars still need to be processed for defect evaluation (software focusing).

While the aspects of the disclosure are described with reference to various implementations and exploitations, it will be understood that these aspects are illustrative and that the scope of the claims is not limited to them. Many variations, modifications, additions, and improvements are possible. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device. Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

### Example Computer

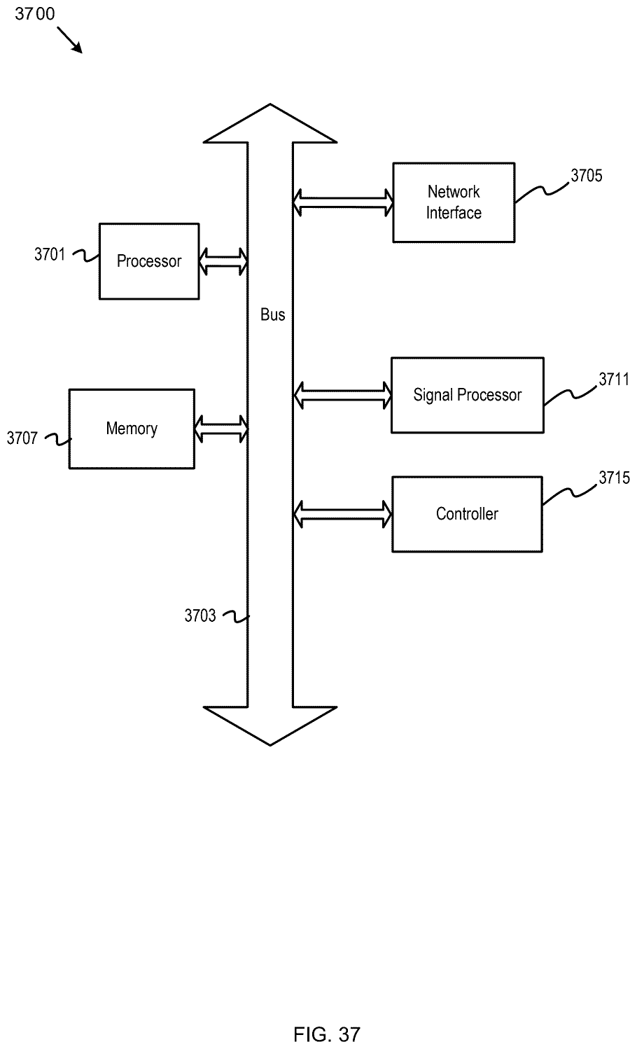

FIG. 37 is a block diagram of an example computer, according to some embodiments. FIG. 37 depicts a computer 3700 that includes a processor 3701 (possibly including multiple processors, multiple cores, multiple nodes, and/or implementing multi-threading, etc.). The computer 3700 includes a memory 3707. The memory 3707 may be system memory or any one or more of the above already described possible realizations of machine-readable media. The computer 3700 also includes a bus 3703 and a network interface 3705.

The computer 3700 also includes a signal processor 3711 and a controller 3715. The signal processor 3711 and the controller 3715 may perform one or more of the operations described herein. For example, the signal processor 3711 may perform processing of the data to detect defects, perform hardware and/or software focusing, etc. The controller 3715 may perform various control operations to a wellbore operation based on the detection of defects.

Any one of the previously described functionalities may be partially (or entirely) implemented in hardware and/or on the processor 3701. For example, the functionality may be implemented with an application specific integrated circuit, in logic implemented in the processor 3701, in a co-processor on a peripheral device or card, etc. Further, realizations may include fewer or additional components not illustrated in FIG. 37 (e.g., video cards, audio cards, additional network interfaces, peripheral devices, etc.). The processor 3701 and the network interface 3705 are coupled to the bus 3703. Although illustrated as being coupled to the bus 3703, the memory 3707 may be coupled to the processor 3701.

While the aspects of the disclosure are described with reference to various implementations and exploitations, it will be understood that these aspects are illustrative and that the scope of the claims is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### EXAMPLE EMBODIMENTS

Embodiment #1: A downhole tool to identify a defect in a wellbore tubular, the downhole tool comprising: a transmitter array of N transmitter coils, wherein a moment of each of the N transmitter coils are to point in a different azimuthal direction, wherein each of the N transmitter coils is configured to emit an excitation signal independent of the other N transmitter coils; and a receiver array of M receiver coils, wherein a moment of each of the M receiver coils are to point in a different azimuthal direction, wherein each of the M receiver coils is configured to measure a response signal derived from the excitation signal from each of the N transmitter coils, wherein a processor is configured to, process, based on a set of scaling weights, the response signal measured by each of the M receiver coils derived from the excitation signals emitted from each of the transmitter coils to create a processed response, wherein the set of scaling weights unique to a radial depth of the wellbore tubular.

Embodiment #2. The downhole tool of Embodiment #1, wherein the processor configured to process the response signal comprises the processor configured to, construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; and construct a scaled actual data matrix based on application of the set of scaling weights to the actual data matrix.

Embodiment #3. The downhole tool of Embodiment #2, wherein the processor is configured to identify the defect in the wellbore tubular based on the scaled actual data matrix.

Embodiment #4. The downhole tool of Embodiment #1, wherein the processor configured to identify the defect comprises the processor configured to identify the defect in the wellbore tubular that includes an identification of the defect that includes a non-averaged azimuth of the defect.

Embodiment #5. The downhole tool of Embodiment #1, wherein the processor is configured to create N×M responses, wherein the processor is configured to identify the defect in the wellbore tubular based on the N×M responses.

Embodiment #6. The downhole tool of Embodiment #1, wherein each of the N transmitter coils is configured to emit the excitation signal with a continuous wave current at one or more frequencies, and wherein each of the M receiver coils is configured to measure at least one of an amplitude and a phase of the response signal or a real part and an imaginary part of a voltage at one or more frequencies of the response signal.

Embodiment #7. The downhole tool of Embodiment #1, wherein each of the N transmitter coils is configured to emit the excitation signal with a pulsed current, and wherein each of the M receiver coils is configured to measure a decay response of a voltage of the response signal at one or more time delays.

Embodiment #8. The downhole tool of Embodiment #7, wherein the processor is configured to process the response signals to create a data matrix of the N×M responses based on each of the one or more time delays of the response signals.

Embodiment #9. The downhole tool of Embodiment #1, further comprising: a controller to transmit a control signal to the N transmitter coils to cause each of the N transmitter coils to emit the excitation signal independent of the other N transmitter coils.

Embodiment #10. The downhole tool of Embodiment #1, wherein the receiver array and the transmitter array are axially separated from each other at a spacing that is proportional to a target depth of the wellbore tubular that is being evaluated for the defects.

Embodiment #11. The downhole tool of Embodiment #1, wherein the receiver array and the transmitter array are axially collocated and having at least one axial length that is proportional to a target depth of investigation.

Embodiment #12. The downhole tool of Embodiment #11, wherein the target depth of investigation is a distance between the wellbore tubular and the downhole tool.

Embodiment #13. The downhole tool of Embodiment #1, wherein a corrective action is to be performed to correct the defect in the wellbore tubular.

Embodiment #14. The downhole tool of Embodiment #13, wherein the corrective action comprises at least one of repairing or replacing a section of the wellbore tubular with the defect.

Embodiment #15. The downhole tool of Embodiment #1, wherein the M receiver coils are non-axial relative to each other.

Embodiment #16. The downhole tool of Embodiment #1, wherein the N transmitter coils are non-axial relative to each other.

Embodiment #17. The downhole tool of Embodiment #1, wherein the wellbore tubular comprises an outer wellbore tubular having at least one inner wellbore tubular within.

Embodiment #18. The downhole tool of Embodiment #1, wherein the wellbore tubular comprises at least one of a casing or a production tubing to be positioned in the wellbore.

Embodiment #19. The downhole tool of Embodiment #1, wherein the processor is configured to, construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; construct a scaled actual data matrix based on application of the set of scaling weights to the actual data matrix; and generate a focused response of the wellbore tubular based on the scaled data matrix, wherein identification of the defect in the wellbore tubular comprises identification of the defect in the wellbore tubular based on the focused response.

Embodiment #20. The downhole tool of Embodiment #19, wherein the reference profile includes at least one of a slot or a hole having a known azimuthal position, size and a penetration depth on the wellbore tubular.

Embodiment #21. The downhole tool of Embodiment #20, wherein the set of scaling weights is specific to the wellbore tubular.

Embodiment #22. The downhole tool of Embodiment #20, wherein the number of reference profiles are arranged into a number of groups according to different widths, wherein the processor is configured to compute a number of sets of scaling weights that includes the set of scaling weights, wherein each group of the number of groups is used to compute an associated set of scaling weights of the number of sets of scaling weights, and wherein the processor is configured to select the set of scaling weights from among the number of sets of scaling weights.

Embodiment #23. The downhole tool of Embodiment #20, wherein the reference profile of the wellbore tubular is based on material properties and dimensions of the wellbore tubular.

Embodiment #24. The downhole tool of Embodiment #20, wherein the processor is configured to construct the training data matrix for the reference profile based on data derived captured from a calibration wellbore.

Embodiment #25. The downhole tool of Embodiment #20, wherein the processor configured to compute the set of scaling weights comprises the processor configured to arrange the set of scaling weights in a weights matrix, such that each column in the weights matrix is a cyclically shifted version of the set of scaling weights; multiply the weights matrix by the training data matrix to construct a product matrix, wherein a main diagonal of the product matrix is matched to a known profile.

Embodiment #26. The downhole tool of Embodiment #20, wherein the processor configured to compute the set of scaling weights comprises the processor configured to minimize a cost function using possible different random noise realizations.

Embodiment #27. The downhole tool of Embodiment #20, wherein values of the training data matrix and values of the set of scaling weights are complex values.

Embodiment #28. The downhole tool of Embodiment #20, wherein values of the training data matrix are at least one of real or imaginary measurements that represent at least one or an amplitude or phase of the response signals, and wherein values of the set of scaling weights are complex values.

Embodiment #29. The downhole tool of Embodiment #20, wherein the processor is configured to subtract background data corresponding to no defects from the training data matrix prior to construction of the training data matrix.

Embodiment #30. The downhole tool of Embodiment #20, wherein the processor configured to construct the scaled actual data matrix comprises the processor configured to multiply of a cyclically shifted set of scaling weights with the actual data matrix to create a product matrix, and wherein the processor configured to generate a focused response comprises the processor configured to generate the focused response based on main diagonal elements of the product matrix.

Embodiment #31. The downhole tool of Embodiment #20, wherein the processor is configured to, adjust emission of the excitation signals by each of the N number of transmitter coils based on the set of scaling weights; and wherein the processed response is created after adjustment of emission of the excitation signals.

Embodiment #32. The downhole tool of Embodiment #1, wherein the processor is configured to, construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; adjust emission of the excitation signals by each of the N number of transmitter coils based on the set of scaling weights; and wherein the processed response is created after adjustment of emission of the excitation signals, wherein values of the training data matrix and values of the set of scaling weights are complex values.

Embodiment #33. The downhole tool of Embodiment #30, wherein the processor configured to adjust emission of the excitation signals comprises the processor configured to adjust at least one of an amplitude or phase of the excitation signals.

Embodiment #34. The downhole tool of Embodiment #29, wherein the processor configured to adjust emission of the excitation signals comprises the processor configured to adjust at least one of amplitude or phase of the excitation signals based on application of cyclically shifted versions of the set of scaling weights.

Embodiment #35. The downhole tool of Embodiment #29, wherein each of the N transmitter coils is configured to emit the excitation signal at least one of sequentially, at different frequencies, at different amplitudes, or with different code sequences.

Embodiment #36. The downhole tool of Embodiment #29, wherein the processor is configured to, construct a scaled actual data matrix based on application of the set of scaling weights to the actual data matrix; and generate a focused response of the wellbore tubular based on the scaled data matrix, wherein identification of the defect in the wellbore tubular comprises identification of the defect in the wellbore tubular based on the focused response.

Embodiment #37. A method comprising: conveying a downhole tool into a wellbore having a wellbore tubular, the downhole tool having a transmitter array of N transmitter coils and a receiver array of M receiver coils, wherein a moment of each of the N transmitter coils points in a different azimuthal direction and a moment of each of the M receiver coils points in a different azimuthal direction; emitting, by each of the N transmitter coils, an excitation signal independent of the other N transmitter coils; measuring, by each of the M receiver coils, a response signal derived from the excitation signal; and processing, based on a set of scaling weights, the response signal measured by each of the M receiver coils derived from the excitation signals emitted from each of the transmitter coils to create a processed response, wherein the set of scaling weights unique to a radial depth of the wellbore tubular.

Embodiment #38. The method of Embodiment #37, wherein processing the response signal comprises, constructing a training data matrix corresponding to a reference profile of a number of reference profiles of the wellbore tubular; computing a set of scaling weights such that a product of multiplying the set of scaling weights with the training data matrix matches the reference profile, wherein the processed response comprises an actual data matrix; and constructing a scaled actual data matrix based on application of the set of scaling weights to the actual data matrix.

Embodiment #39. The method of Embodiment #38, further comprising identifying the defect in the wellbore tubular based on the scaled actual data matrix.

Embodiment #40. The method of Embodiment #37, wherein identifying the defect in the wellbore tubular comprises identifying the defect in the wellbore tubular that includes an identification of the defect that includes a non-averaged azimuth of the defect.

Embodiment #41. The method of Embodiment #37, wherein the processed response comprises N×M responses, and wherein identifying the defect comprises identifying the defect in the wellbore tubular based on the N×M responses.

Embodiment #42. The method of Embodiment #37, wherein emitting, by each of the N transmitter coils, the excitation signal comprises emitting, by each of the N transmitter coils, the excitation signal with a continuous wave current at one or more frequencies, and wherein measuring, by each of the M receiver coils, the response signal comprises measuring at least one of an amplitude and a phase of the response signal or a real part and an imaginary part of a voltage at one or more frequencies of the response signal.

Embodiment #43. The method of Embodiment #37, wherein emitting, by each of the N transmitter coils, the excitation signal comprises emitting, by each of the N transmitter coils, the excitation signal with a pulsed current, wherein measuring, by each of the M receiver coils, the response signal comprises measuring a decay response of a voltage of the response signal at one or more time delays.

Embodiment #44. The method of Embodiment #43, further comprising: processing the response signals to create a data matrix of the N×M responses based on each of the one or more time delays of the response signals.

Embodiment #45. The method of Embodiment #37, wherein the receiver array and the transmitter array are axially separated from each other at a spacing that is proportional to a target depth of the wellbore tubular that is being evaluated for the defects.

Embodiment #46. The method of Embodiment #37, wherein the receiver array and the transmitter array are axially collocated and having at least one axial length that is proportional to a target depth of investigation.

Embodiment #47. The method of Embodiment #46, wherein the target depth of investigation is a distance between the wellbore tubular and the downhole tool.

Embodiment #48. The method of Embodiment #43, performing a corrective action to correct the defect in the wellbore tubular.

Embodiment #49. The method of Embodiment #48, wherein the corrective action comprises at least one of repairing or replacing a section of the wellbore tubular with the defect.

Embodiment #50. The method of Embodiment #37, wherein the M receiver coils are non-axial relative to each other.

Embodiment #51. The method of Embodiment #37, wherein the N transmitter coils are non-axial relative to each other.

Embodiment #52. The method of Embodiment #37, wherein the wellbore tubular comprises an outer wellbore tubular having at least one inner wellbore tubular within.

Embodiment #53. The method of Embodiment #37, wherein the wellbore tubular comprises at least one of a casing or a production tubing to be positioned in the wellbore.

Embodiment #54. The method of Embodiment #37, further comprising: constructing a training data matrix corresponding to a reference profile of a number of reference profiles of the wellbore tubular; computing a set of scaling weights such that a product of multiplying the set of scaling weights with the training data matrix matches the reference profile, wherein the processed response comprises an actual data matrix; constructing a scaled actual data matrix based on application of the set of scaling weights to the actual data matrix; and generating a focused response of the wellbore tubular based on the scaled data matrix, wherein identifying the defect comprises identifying the defect in the wellbore tubular based on the focused response.

Embodiment #55. The method of Embodiment #54, wherein the reference profile includes at least one of a slot or a hole having a known azimuthal position, size and a penetration depth on the wellbore tubular.

Embodiment #56. The method of Embodiment #54, wherein the set of scaling weights is specific to the wellbore tubular.

Embodiment #57. The method of Embodiment #54, wherein the number of reference profiles are arranged into a number of groups according to different widths, wherein the method comprises computing a number of sets of scaling weights that includes the set of scaling weights, wherein each group of the number of groups is used to compute an associated set of scaling weights of the number of sets of scaling weights, and wherein the processor is configured to select the set of scaling weights from among the number of sets of scaling weights.

Embodiment #58. The method of Embodiment #54, wherein the reference profile of the wellbore tubular is based on material properties and dimensions of the wellbore tubular.

Embodiment #59. The method of Embodiment #54, wherein constructing the training data matrix comprises constructing the training data matrix for the reference profile based on data derived captured from a calibration wellbore.

Embodiment #60. The method of Embodiment #54, wherein computing the set of scaling weights comprises, arranging the set of scaling weights in a weights matrix, such that each column in the weights matrix is a cyclically shifted version of the set of scaling weights; multiplying the weights matrix by the training data matrix to construct a product matrix, wherein a main diagonal of the product matrix is matched to the known profile.

Embodiment #61. The method of Embodiment #54, wherein computing the set of scaling weights comprises t minimizing a cost function using possible different random noise realizations.

Embodiment #62. The method of Embodiment #54, wherein values of the training data matrix and values of the set of scaling weights are complex values.

Embodiment #63. The method of Embodiment #54, wherein values of the training data matrix are at least one of real or imaginary measurements that represent at least one or an amplitude or phase of the response signals, and wherein values of the set of scaling weights are complex values.

Embodiment #64. The method of Embodiment #54, further comprising: subtracting background data corresponding to no defects from the training data matrix prior to construction of the training data matrix.

Embodiment #65. The method of Embodiment #54, wherein constructing the scaled actual data matrix comprises multiplying of a cyclically shifted set of scaling weights with the actual data matrix to create a product matrix, and wherein generating a focused response comprises generating the focused response based on main diagonal elements of the product matrix.

Embodiment #66. The method of Embodiment #37, constructing a training data matrix corresponding to a reference profile of a number of reference profiles of the wellbore tubular; computing a set of scaling weights such that a product of multiplying the set of scaling weights with the training data matrix matches the reference profile, wherein the processed response comprises an actual data matrix; adjusting emission of the excitation signals by each of the N number of transmitter coils based on the set of scaling weights; and wherein the processed response is created after adjustment of emission of the excitation signals.

Embodiment #67. The method of Embodiment #66, wherein values of the training data matrix and values of the set of scaling weights are complex values.

Embodiment #69. The method of Embodiment #67, wherein adjusting emission of the excitation signals comprises adjusting at least one of an amplitude or phase of the excitation signals.

Embodiment #70. The method of Embodiment #68, wherein adjusting emission of the excitation signals comprises adjusting at least one of amplitude or phase of the excitation signals based on application of cyclically shifted versions of the set of scaling weights.

Embodiment #71. The method of Embodiment #68, wherein emitting, by each of the N transmitter coils, the excitation signal comprises emitting, by each of the N transmitter coils, the excitation signal at least one of sequentially, at different frequencies, at different amplitudes, or with different code sequences.

Embodiment #72. The method of Embodiment #68, further comprising: constructing a scaled actual data matrix based on application of the set of scaling weights to the actual data matrix; and generating a focused response of the wellbore tubular based on the scaled data matrix, wherein identifying the defect in the wellbore tubular comprises identifying the defect in the wellbore tubular based on the focused response.

Embodiment #73. A system comprising: a downhole tool to identify a defect in a wellbore tubular, the downhole tool comprising, a transmitter array of N transmitter coils, wherein a moment of each of the N transmitter coils are to point in a different azimuthal direction, wherein each of the N transmitter coils is configured to emit an excitation signal independent of the other N transmitter coils; and a receiver array of M receiver coils, wherein a moment of each of the M receiver coils are to point in a different azimuthal direction, wherein each of the M receiver coils is configured to measure a response signal derived from the excitation signal from each of the N transmitter coils, a processor; and a computer-readable medium having instructions stored thereon that are executable by the processor to cause the processor to, process, based on a set of scaling weights, the response signal measured by each of the M receiver coils derived from the excitation signals emitted from each of the transmitter coils to create a processed response, wherein the set of scaling weights unique to a radial depth of the wellbore tubular.

Embodiment #74. The system of Embodiment #73, wherein the instructions executable by the processor to cause the processor to the response signal comprises instructions executable by the processor to cause the processor to, construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; and construct a scaled actual data matrix based on application of the set of scaling weights to the actual data matrix.

Embodiment #75. The system of Embodiment #74, wherein the instructions comprise instructions executable by the processor to cause the processor to identify the defect in the wellbore tubular based on the scaled actual data matrix.

Embodiment #76. The system of Embodiment #73, wherein the instructions executable by the processor to cause the processor to identify the defect comprises instructions executable by the processor to cause the processor to identify the defect in the wellbore tubular that includes an identification of the defect that includes a non-averaged azimuth of the defect.

Embodiment #77. The system of Embodiment #73, wherein the instructions comprise instructions that are executable by the processor to cause the processor to create N×M responses, and wherein the instructions that are executable by the processor to cause the processor to identify the defect comprises instructions that are executable by the processor to cause the processor to identify the defect in the wellbore tubular based on the N×M responses.

Embodiment #78. The system of Embodiment #73, wherein each of the N transmitter coils is configured to emit the excitation signal with a continuous wave current at one or more frequencies, and wherein each of the M receiver coils is configured to measure at least one of an amplitude and a phase of the response signal or a real part and an imaginary part of a voltage at one or more frequencies of the response signal.

Embodiment #79. The system of Embodiment #78, wherein each of the N transmitter coils is configured to emit the excitation signal with a pulsed current, and wherein each of the M receiver coils is configured to measure a decay response of a voltage of the response signal at one or more time delays.

Embodiment #80. The system of Embodiment #79, wherein the instructions comprise instructions executable by the processor to cause the processor to process the response signals to create a data matrix of the N×M responses based on each of the one or more time delays of the response signals.

Embodiment #81. The system of Embodiment #73, further comprising: a controller to transmit a control signal to the N transmitter coils to cause each of the N transmitter coils to emit the excitation signal independent of the other N transmitter coils.

Embodiment #82. The system of Embodiment #73, wherein the receiver array and the transmitter array are axially separated from each other at a spacing that is proportional to a target depth of the wellbore tubular that is being evaluated for the defects.

Embodiment #83. The system of Embodiment #73, wherein the receiver array and the transmitter array are axially collocated and having at least one axial length that is proportional to a target depth of investigation.

Embodiment #84. The system of Embodiment #83, wherein the target depth of investigation is a distance between the wellbore tubular and the downhole tool.

Embodiment #85. The system of Embodiment #73, wherein a corrective action is to be performed to correct the defect in the wellbore tubular.

Embodiment #86. The system of Embodiment #85, wherein the corrective action comprises at least one of repairing or replacing a section of the wellbore tubular with the defect.

Embodiment #87. The system of Embodiment #73, wherein the M receiver coils are non-axial relative to each other.

Embodiment #88. The system of Embodiment #73, wherein the N transmitter coils are non-axial relative to each other.

Embodiment #89. The system of Embodiment #73, wherein the wellbore tubular comprises an outer wellbore tubular having at least one inner wellbore tubular within.

Embodiment #90. The system of Embodiment #73, wherein the wellbore tubular comprises at least one of a casing or a production tubing to be positioned in the wellbore.

Embodiment #91. The system of Embodiment #73, wherein the instructions comprise instructions executable by the processor to cause the processor to, construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; construct a scaled actual data matrix based on application of the set of scaling weights to the actual data matrix; and generate a focused response of the wellbore tubular based on the scaled data matrix, wherein identification of the defect in the wellbore tubular comprises identification of the defect in the wellbore tubular based on the focused response.

Embodiment #92. The system of Embodiment #91, wherein the reference profile includes at least one of a slot or a hole having a known azimuthal position, size and a penetration depth on the wellbore tubular.

Embodiment #93. The system of Embodiment #91, wherein the set of scaling weights is specific to the wellbore tubular.

Embodiment #94. The system of Embodiment #91, wherein the number of reference profiles are arranged into a number of groups according to different widths, wherein the instructions comprise instructions executable by the processor to cause the processor to compute a number of sets of scaling weights that includes the set of scaling weights, wherein each group of the number of groups is used to compute an associated set of scaling weights of the number of sets of scaling weights, and wherein the instructions comprise instructions executable by the processor to cause the processor to select the set of scaling weights from among the number of sets of scaling weights.

Embodiment #95. The system of Embodiment #91, wherein the reference profile of the wellbore tubular is based on material properties and dimensions of the wellbore tubular.

Embodiment #96. The system of Embodiment #91, wherein the instructions executable by the processor to cause the processor to construct the training data matrix comprise instructions executable by the processor to cause the processor to construct the training data matrix for the reference profile based on data derived captured from a calibration wellbore.

Embodiment #97. The system of Embodiment #91, wherein the instructions executable by the processor to cause the processor to compute the set of scaling weights comprise instructions executable by the processor to cause the processor to, arrange the set of scaling weights in a weights matrix, such that each column in the weights matrix is a cyclically shifted version of the set of scaling weights; multiply the weights matrix by the training data matrix to construct a product matrix, wherein a main diagonal of the product matrix is matched to the known profile.

Embodiment #98. The system of Embodiment #91, wherein the instructions executable by the processor to cause the processor to compute the set of scaling weights comprises instructions executable by the processor to cause the processor to minimize a cost function using possible different random noise realizations.

Embodiment #99. The system of Embodiment #91, wherein values of the training data matrix and values of the set of scaling weights are complex values.

Embodiment #100. The system of Embodiment #91, wherein values of the training data matrix are at least one of real or imaginary measurements that represent at least one or an amplitude or phase of the response signals, and wherein values of the set of scaling weights are complex values.

Embodiment #101. The system of Embodiment #91, wherein the instructions comprise instructions executable by the processor to cause the processor to, subtract background data corresponding to no defects from the training data matrix prior to construction of the training data matrix.

Embodiment #102. The system of Embodiment #91, wherein the instructions executable by the processor to cause the processor to construct the scaled actual data matrix comprises instructions executable by the processor to cause the processor to multiply of a cyclically shifted set of scaling weights with the actual data matrix to create a product matrix, and wherein the instructions executable by the processor to cause the processor to generate a focused response comprises instructions executable by the processor to cause the processor to generate the focused response based on main diagonal elements of the product matrix.

Embodiment #103. The system of Embodiment #73, wherein the instructions comprise instructions executable by the processor to cause the processor to construct a training data matrix corresponding to a reference profile of a number of reference profiles of the wellbore tubular; compute a set of scaling weights such that a product of multiplying the set of scaling weights with the training data matrix matches the reference profile, wherein the processed response comprises an actual data matrix; adjust emission of the excitation signals by each of the N number of transmitter coils based on the set of scaling weights; and wherein the processed response is created after adjustment of emission of the excitation signals.

Embodiment #104. The system of Embodiment #103, wherein values of the training data matrix and values of the set of scaling weights are complex values.

Embodiment #105. The system of Embodiment #104, wherein the instructions executable by the processor to cause the processor to adjust emission of the excitation signals comprise instructions executable by the processor to cause the processor to adjust at least one of an amplitude or phase of the excitation signals.

Embodiment #106. The system of Embodiment #103, wherein the instructions executable by the processor to cause the processor to adjust emission of the excitation signals comprise instructions executable by the processor to cause the processor to adjust at least one of amplitude or phase of the excitation signals based on application of cyclically shifted versions of the set of scaling weights.

Embodiment #107. The system of Embodiment #103, wherein each of the N transmitter coils is configured to emit the excitation signal at least one of sequentially, at different frequencies, at different amplitudes, or with different code sequences.

Embodiment #108. The system of Embodiment #103, wherein the instructions comprise instructions executable by the processor to cause the processor to, construct a scaled actual data matrix based on application of the set of scaling weights to the actual data matrix; and generate a focused response of the wellbore tubular based on the scaled data matrix, wherein identification of the defect in the wellbore tubular comprises identification of the defect in the wellbore tubular based on the focused response.

1. A downhole tool to identify a defect in a wellbore tubular, the downhole tool comprising:
a transmitter array of N transmitter coils, wherein a moment of each of the N transmitter coils are to point in a different azimuthal direction, wherein each of the N transmitter coils is configured to emit an excitation signal independent of the other N−1 transmitter coils; and
a receiver array of M receiver coils, wherein a moment of each of the M receiver coils are to point in a different azimuthal direction, wherein each of the M receiver coils is configured to measure a response signal derived from the excitation signal from each of the N transmitter coils,
wherein a processor is configured to,
process, based on a set of scaling weights, the response signal measured by each of the M receiver coils derived from the excitation signals emitted from each of the transmitter coils to create a processed response, wherein the set of scaling weights is unique to a radial depth of the wellbore tubular.

2. The downhole tool of claim 1, wherein the processor configured to process the response signal comprises the processor configured to,
construct a training data matrix corresponding to a reference profile of a number of reference profiles of the wellbore tubular;
compute a set of scaling weights such that a product of multiplying the set of scaling weights with the training data matrix matches the reference profile, wherein the processed response comprises an actual data matrix; and
construct a scaled actual data matrix based on application of the set of scaling weights to the actual data matrix.

3. The downhole tool of claim 2, wherein the processor is configured to identify the defect in the wellbore tubular based on the scaled actual data matrix.

4. The downhole tool of claim 3, wherein the processor configured to identify the defect comprises the processor configured to identify the defect that includes a non-averaged azimuth of the defect.

5. The downhole tool of claim 1, wherein a corrective action is to be performed to correct the defect in the wellbore tubular, wherein the corrective action comprises at least one of repairing or replacing a section of the wellbore tubular with the defect.

6. The downhole tool of claim 1, wherein the processor is configured to,
construct a training data matrix corresponding to a reference profile of a number of reference profiles of the wellbore tubular;
compute a set of scaling weights such that a product of multiplying the set of scaling weights with the training data matrix matches the reference profile, wherein the processed response comprises an actual data matrix;
construct a scaled actual data matrix based on application of the set of scaling weights to the actual data matrix; and
generate a focused response of the wellbore tubular based on the scaled data matrix,
wherein identification of the defect in the wellbore tubular comprises identification of the defect in the wellbore tubular based on the focused response.

7. The downhole tool of claim 6,
wherein the processor configured to compute the set of scaling weights comprises the processor configured to
arrange the set of scaling weights in a weights matrix, such that each column in the weights matrix is a cyclically shifted version of the set of scaling weights;
multiply the weights matrix by the training data matrix to construct a product matrix, wherein a main diagonal of the product matrix is matched to a known profile.

8. The downhole tool of claim 6,
wherein the processor configured to construct the scaled actual data matrix comprises the processor configured to multiply of a cyclically shifted set of scaling weights with the actual data matrix to create a product matrix, and
wherein the processor configured to generate a focused response comprises the processor configured to generate the focused response based on main diagonal elements of the product matrix.

9. The downhole tool of claim 6,
wherein the processor is configured to,
adjust emission of the excitation signals by each of the N number of transmitter coils based on the set of scaling weights; and
wherein the processed response is created after adjustment of emission of the excitation signals.

10. The downhole tool of claim 9,
wherein the processor is configured to,
construct a training data matrix corresponding to a reference profile of a number of reference profiles of the wellbore tubular;
compute a set of scaling weights such that a product of multiplying the set of scaling weights with the training data matrix matches the reference profile, wherein the processed response comprises an actual data matrix;
adjust emission of the excitation signals by each of the N number of transmitter coils based on the set of scaling weights; and
wherein the processed response is created after adjustment of emission of the excitation signals, wherein values of the training data matrix and values of the set of scaling weights are complex values.

11. The downhole tool of claim 10, wherein the processor configured to adjust emission of the excitation signals comprises the processor configured to adjust at least one of amplitude or phase of the excitation signals based on application of cyclically shifted versions of the set of scaling weights.

12. A method comprising:
conveying a downhole tool into a wellbore having a wellbore tubular, the downhole tool having a transmitter array of N transmitter coils and a receiver array of M receiver coils, wherein a moment of each of the N transmitter coils points in a different azimuthal direction and a moment of each of the M receiver coils points in a different azimuthal direction;
emitting, by each of the N transmitter coils, an excitation signal independent of the other N−1 transmitter coils;
measuring, by each of the M receiver coils, a response signal derived from the excitation signal; and
processing, based on a set of scaling weights, the response signal measured by each of the M receiver coils derived from the excitation signals emitted from each of the transmitter coils to create a processed response, wherein the set of scaling weights is unique to a radial depth of the wellbore tubular.

13. The method of claim 12, wherein processing the response signal comprises,
constructing a training data matrix corresponding to a reference profile of a number of reference profiles of the wellbore tubular;
computing a set of scaling weights such that a product of multiplying the set of scaling weights with the training data matrix matches the reference profile, wherein the processed response comprises an actual data matrix; and
constructing a scaled actual data matrix based on application of the set of scaling weights to the actual data matrix.

14. The method of claim 13, further comprising identifying the defect in the wellbore tubular based on the scaled actual data matrix.

15. The method of claim 14, wherein identifying the defect in the wellbore tubular comprises identifying the defect in the wellbore tubular that includes an identification of the defect that includes a non-averaged azimuth of the defect.

16. The method of claim 14, further comprising:
constructing a training data matrix corresponding to a reference profile of a number of reference profiles of the wellbore tubular;
computing a set of scaling weights such that a product of multiplying the set of scaling weights with the training data matrix matches the reference profile, wherein the processed response comprises an actual data matrix;
constructing a scaled actual data matrix based on application of the set of scaling weights to the actual data matrix; and
generating a focused response of the wellbore tubular based on the scaled data matrix,
wherein identifying the defect comprises identifying the defect in the wellbore tubular based on the focused response.

17. A system comprising:
a downhole tool to identify a defect in a wellbore tubular, the downhole tool comprising,
a transmitter array of N transmitter coils, wherein a moment of each of the N transmitter coils are to point in a different azimuthal direction, wherein each of the N transmitter coils is configured to emit an excitation signal independent of the other N−1 transmitter coils; and
a receiver array of M receiver coils, wherein a moment of each of the M receiver coils are to point in a different azimuthal direction, wherein each of the M receiver coils is configured to measure a response signal derived from the excitation signal from each of the N transmitter coils,
a processor; and
a computer-readable medium having instructions stored thereon that are executable by the processor to cause the processor to,
process, based on a set of scaling weights, the response signal measured by each of the M receiver coils derived from the excitation signals emitted from each of the transmitter coils to create a processed response, wherein the set of scaling weights is unique to a radial depth of the wellbore tubular.

18. The system of claim 17, wherein the instructions executable by the processor to cause the processor to the response signal comprises instructions executable by the processor to cause the processor to,
construct a training data matrix corresponding to a reference profile of a number of reference profiles of the wellbore tubular;
compute a set of scaling weights such that a product of multiplying the set of scaling weights with the training data matrix matches the reference profile, wherein the processed response comprises an actual data matrix; and
construct a scaled actual data matrix based on application of the set of scaling weights to the actual data matrix.

19. The system of claim 18, wherein the instructions comprise instructions executable by the processor to cause the processor to identify the defect in the wellbore tubular based on the scaled actual data matrix.

20. The system of claim 19, wherein the instructions executable by the processor to cause the processor to identify the defect comprises instructions executable by the processor to cause the processor to identify the defect in the wellbore tubular that includes an identification of the defect that includes a non-averaged azimuth of the defect.
